(19) United States
(12) Patent Application Publication
(10) Pub. No.: US 2012/0075667 A1
(43) Pub. Date: Mar. 29, 2012

(54) COMMUNICATION SYSTEM, COMMUNICATION DEVICE, SERVER SYSTEM AND RECORDING MEDIUM

(75) Inventor: Keitaro KAMATA, Nagoya-shi (JP)

(73) Assignee: Buffalo Inc., Nagoya-shi (JP)

(21) Appl. No.: 13/235,401

(22) Filed: Sep. 18, 2011

(30) Foreign Application Priority Data
Sep. 28, 2010 (JP) 2010-217031

(51) Int. Cl. G06F 3/12

(52) U.S. Cl. 358/1.15

(57) ABSTRACT

A communication system is allowed to use one or more electronic devices connected with a device interface of a server system by communicating with the server system via a network. The communication system or the server system notifies to a user a correspondence relation between items, including those identifying the electronic device and a port connected with the electronic device.

### CROSS-REFERENCE TO RELATED APPLICATION

This application claims the benefit of Japanese Patent Application No. 2010-217031 filed on Sep. 28, 2010, the entire disclosure of which is incorporated herein by reference

### BACKGROUND OF THE INVENTION

1. Field of the Invention

The present invention relates to a communication system, a communication device, a server system and a recording medium

2. Description of the Related Art

Heretofore, there has been known a USB (Universal Series Bus) device server which allows a communication device (e.g., a personal computer connectable with a network) to use a USB device via a network as disclosed in e.g., Japanese unexamined patent application publication 2007-310796. Some of such device servers include a plurality of USB ports (ports for use in connecting with the USB devices). Alternatively, by connecting a USB hub with the USB port of the device server, a plurality of the USB devices may be connected with the device server, so that the communication device can use a plurality of the USB devices via the device server.

A plurality of the USB devices of the same type can be connected with the conventional device server described above. For example, a plurality of USB flash memories (or USB flash drives) can be connected with the device server. For the sake of properly using a specific USB device, it is desirable that a user of the communication device can distinguish the specific USB device from other USB devices. For example, when starting the use of a specific USB device, or terminating the use of the specific USB device and then removing it from the device server, it is desirable that the specific USB device can be distinguished from other USB devices.

According to the conventional device servers, however, when a plurality of the USB devices of the same type are connected therewith, the plurality of the USB devices are not distinguished from one another in the communication device, but are enumerated as the USB devices of the same type, thus imposing a heavy burden on a user to distinguish the specific USB device from other USB devices.

This kind of problem occurs not only when using a USB device the interface standard of which is the USB standards, but also when using an electronic device (a peripheral device) connected by means of an interface of any arbitrary standard.

### SUMMARY OF THE INVENTION

It is, therefore, an object of the present invention to provide a technique for relieving the burden on a user when distinguishing a specific electronic device from other ones.

The present invention is applicable to a communication system including a communication device and a server system connected with each other in a manner capable of communicating via a network, the server system allowing the communication device to use at least one electronic device via the network,

wherein the server system includes:

a network interface to the network;

a device interface having a function to provide for use of a plurality of ports for connecting with the electronic device;

a device interface relay unit for relaying data communication between the communication device and the device interface via the network interface in order to allow the communication device to form a virtual device interface corresponding to the device interface of the server system; and

a correspondence relation output unit for outputting data on a correspondence relation between a plurality of items, including items identifying the electronic device connected with the port of the device interface and the port connected with the electronic device, and

wherein the communication device includes:

a network interface to the network;

a virtual interface control unit for forming a virtual device interface corresponding to the device interface of the server system, by communicating with the server system via the network;

a notification unit for notifying information to a user; and

a notification control unit for allowing the notification unit to notify a correspondence relation between a plurality of items, including items identifying the electronic device connected with the port of the device interface and the port connected with the electronic device, based on the data from the correspondence relation output unit.

According to this system, the notification control unit allows the notification unit to notify the correspondence relation between the plurality of the items, including items identifying the electronic device and the port. Hence, the user can easily distinguish a specific electronic device from the other electronic devices.

Also, the present invention is applied to a communication device including:

a network interface to a network;

a virtual interface control unit for forming a virtual device interface corresponding to a device interface of a server system, by communicating, via the network, with the server system including the device interface having a function to provide for use of a plurality of ports for connecting with at least one electronic device;

a notification unit for notifying information to a user; and

a notification control unit for allowing the notification unit to notify a correspondence relation between a plurality of items, including items identifying the electronic device connected with the port of the device interface and the port connected with the electronic device.

According to this system, the notification control unit allows the notification unit to notify the correspondence relations between the plurality of the items, including items identifying the electronic device and the port. Hence, the user can easily distinguish a specific electronic device from the other electronic devices.

Here, the server system may include a port distinguishing display unit as a display unit operable as the notification unit to display one port selected from among a plurality of the ports in a manner distinguishable from the other ports, in which the notification control unit may include a display command transmission unit which obtains device identifying information for identifying one electronic device from among one or more electronic devices connected with the server system and then transmits, to the server system, a command to allow the port distinguishing display unit to display the port connected with the electronic device identified by the device identifying information in a manner distinguishable from the other ports.

Further, the communication device may include an image display unit acting as a display unit operable as the notification unit, in which the notification control unit further includes a position image control unit for allowing the image display unit to display a position image showing a physical positional relationship between a plurality of the ports, and, the position image control unit obtains device identifying information for identifying one electronic device from among one or more electronic devices connected with the server system to thereby allow the image display unit to display the position image showing the port connected with the electronic device identified by the device identifying information in a manner distinguishable from the other ports.

Furthermore, the information control unit may include a user selection unit for allowing a user to select information associated with one electronic device from among one or more electronic devices connected with the server system, in which the device identifying information may include the information for identifying the electronic device associated with the information selected by the user.

Also, the device identifying information may include the information for identifying an electronic device selected to be used by the communication device from among one or more electronic devices connected with the server system.

Still also, the notification control unit may allow the notification unit to notify the correspondence relation including, as one of the plurality of the items in the correspondence relation, the information indicating the time at which the electronic device was connected with the port.

Also, the notification control unit may allow the notification unit to notify the correspondence relation including, as one of the plurality of the items in the correspondence relation, the information indicating the time at which an electronic device started to be used.

Further, when the electronic device is a storage device for providing a storage region for storing data, the notification control unit may allow the notification unit to notify the correspondence relation including, as one of a plurality of items in the correspondence relation, an identifier of the storage region used to identify the storage region in the communication device.

Furthermore, the present invention is applied to a communication device including:

a network interface to a network;

a virtual interface control unit for forming a virtual device interface corresponding to a device interface of a server system, by communicating, via the network, with the server system including the device interface having a function to provide for use of a plurality of ports for connecting with one or more electronic devices; and

a notification control unit for outputting data for notifying to a user information on a correspondence relation between a plurality of items, including items identifying an electronic device connected with the port of the device interface and the port connected with the electronic device.

Moreover, the present invention is a non-volatile recording medium with such a program stored therein that enables a computer, which includes a network interface to a network and a notification unit for notifying information to a user, to have a function to allow the notification unit to notify a correspondence relation between a plurality of items, including items identifying at least one electronic device connected with a port of a device interface and the port connected with the electronic device, by allowing the computer to communicate with, via the network, a server system including the device interface providing for use of a plurality of ports for connecting with the at least one electronic device.

Besides, the present invention is applied to a server system for allowing a communication device to use one or more electronic devices via a network, the server system including:

a network interface to a network;

a device interface having a function to provide for use of a plurality of ports for connecting with the electronic device;

a device interface relay unit for relaying data communication between the communication device and the device interface via the network interface in order to allow the communication device to form a virtual device interface corresponding to the device interface of the server system;

a sever system side notification unit for notifying information to a user; and

a correspondence relation output unit for allowing the sever system side notification unit for notifying information to a user to notify a correspondence relation between a plurality of items, including items identifying the electronic device connected with the port of the device interface and the port connected with the electronic device.

Additionally, the present invention is applied to a server system for allowing a communication device to use one or more electronic devices via a network, the server system including:

a network interface to a network;

a device interface having a function to provide for use of a plurality of ports for connecting with the electronic device;

a device interface relay unit for relaying data communication between the communication device and the device interface via the network interface in order to allow the communication device to form a virtual device interface corresponding to the device interface of the server system; and

a correspondence relation output unit for outputting data for notifying to a user information on a correspondence relation between a plurality of items, including items identifying the electronic device connected with the port of the device interface and the port connected with the electronic device.

Furthermore, the present invention is directed to a non-volatile recording medium with such a program stored therein that enables a computer which includes a network interface to a network, a device interface providing for use of a plurality of ports for connecting with one or more electronic devices, and a server system side notification unit for notifying information to a user, to have a function to output data for allowing the server system side notification unit to notify a correspondence relation between a plurality of items, including items identifying the electronic device connected with the port of the device interface and the port connected with the electronic device.

It should be noted that the present invention can be realized through a variety of embodiments. For example, the present invention can be realized in the forms of a method or a server system for allowing a communication device to use an electronic device via a network; a network system including a server system and a communication device; a computer program for realizing the functions of the method or the system; and a recording medium on which the computer program has been recorded, and so on.

### BRIEF DESCRIPTION OF THE DRAWINGS

These objects and other objects and advantages of the present invention will become more apparent upon reading of the following detailed description and the accompanying drawings in which:

FIG. 1 is an explanatory drawing illustrating a communication system according to a first embodiment of the present invention.

FIG. 2 is a block diagram illustrating the configurations of a communication device and a device server according to the first embodiment.

FIG. 3 is a block diagram illustrating one example of the behavior of the system according to the first embodiment.

FIG. 4 is an explanatory diagram illustrating one example of a management screen 160d according to the first embodiment.

FIG. 5 is a block diagram illustrating another example of the behavior of the system according to the first embodiment.

FIG. 6 is a block diagram illustrating yet another example of the behavior of the system according to the first embodiment.

FIG. 7 is a block diagram illustrating yet another example of the behavior of the system according to the first embodiment.

FIG. 8 is a block diagram illustrating a behavior of a communication system according to a second embodiment of the present invention.

FIG. 9 is an explanatory diagram illustrating one example of a management screen according to the second embodiment.

FIG. 10 is a block diagram illustrating one example of a behavior of a communication system according to a third embodiment of the present invention.

FIG. 11 is an explanatory drawing illustrating one example of a management screen of a communication system according to a fourth embodiment of the present invention.

FIG. 12 is a block diagram illustrating the configuration of a communication system according to a fifth embodiment of the present invention.

FIG. 13 is a block diagram illustrating one example of a behavior of a system according to a fifth embodiment of the present invention.

FIG. 14 is a block diagram illustrating other example of the behavior of the system according to the fifth embodiment.

FIG. 15 is a block diagram illustrating one example of a behavior of a communication system according to a sixth embodiment of the present invention.

FIG. 16 is a block diagram illustrating the configuration of a communication system according to a seventh embodiment of the present invention.

FIG. 17 is an explanatory drawing illustrating one example of a management screen of a communication device according to an eighth embodiment of the present invention.

### DESCRIPTION OF PREFERRED EMBODIMENTS

Next is a description of embodiments according to the present invention with reference to accompanying drawings.

### First Embodiment

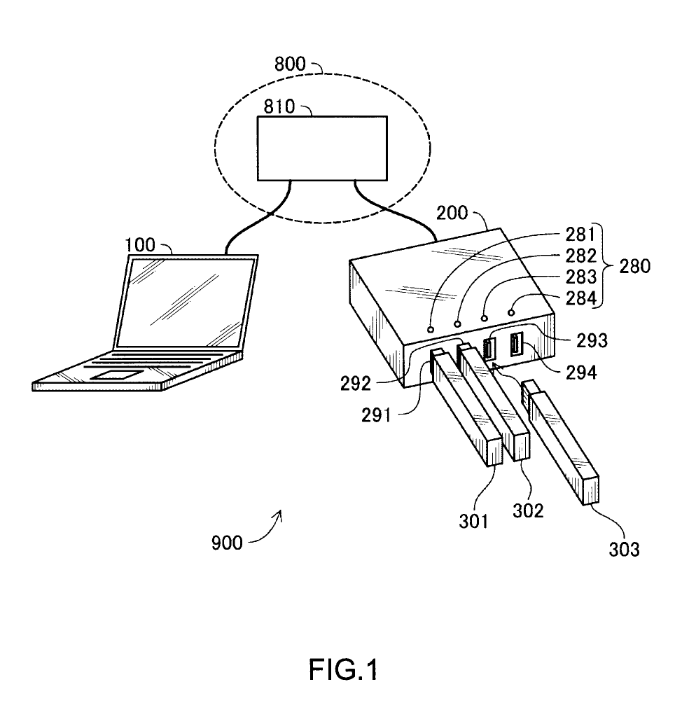

FIG. 1 is an explanatory drawing illustrating a communication system (hereinafter, simply referred to as “system” in some cases) 900 according to a first embodiment of the present invention. This system 900 includes a communication device 100, a device server 200, USB devices 301, 302, 303, and a network 800. The communication device 100 and the device server 200 are connected with the network 800.

The network 800 includes a relay device 810 (e.g., a router and a switching hub) and relays communication between a plurality of the communication devices. In addition, the architecture of the network 800 is not limited to that shown in FIG. 1 and may be an arbitrarily different one. The network 800, e.g., may include a plurality of relay devices and instead of this one 800, may be one communication line connecting the communication device 100 and the device server 200.

The device server (a server system) 200 includes a USB interface to allow a different electronic device to use USB devices (e.g., the USB devices 301 to 303) via a network (according to the present embodiment, the network 800). According to the present embodiment, the device server 200 includes four USB ports 291 to 294 and four lamps 281 to 284 corresponding to the four USB ports 291 to 294. First to fourth USB ports 291 to 294 are laid out in a line. The first lamp 281 is arranged near the first USB port 291 and similarly the second lamp 282, the third lamp 283 and the fourth lamp 284 are arranged near the second USB port 292, the third USB port 293 and the fourth USB port 294, respectively. A user can easily identify that one lamp is associated with one USB port.

Three USB devices 301 to 303 are all USB memories (or USB flash drives). The USB memories 301 to 303 each provide a storage region for storing data. The USB memories 301 to 303 each include, e.g., a readable/writable flash memory. In FIG. 1, the first USB memory 301 is mounted on the first USB port 291 and the second USB memory 302 is mounted on the second USB port 292. The third USB memory 303 is not connected with the device server 200. In addition, a USB device for providing a storage region for storing data is not limited to a device with a flash memory and a variety of other devices (e.g., a device with a hard disc drive) for providing a storage region may be applicable. Further, USB devices (e.g., the USB devices 301 to 303) connected with the device server 200 is not limited to USB memories and other arbitrary USB devices (e.g., a printer and a television tuner) may be applicable.

The communication device 100 is a general-purpose personal computer. The communication device 100 is connected with the device server 200 via the network 800. The communication device 100 is allowed to use a USB device (e.g., the USB memory 301) via the device serve 200.

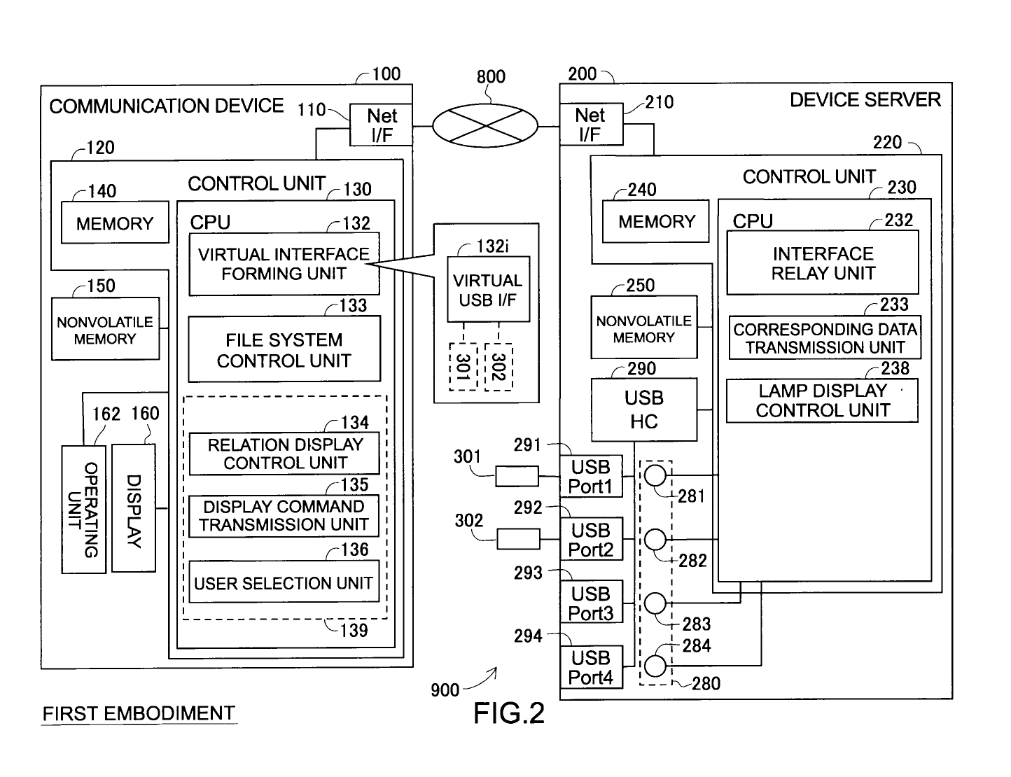

FIG. 2 is a block diagram illustrating the configuration of the communication device 100 and device server 200. The communication device 100 includes a network interface 110, a control unit 120, a nonvolatile memory 150, a display 160 and an operating unit 162. The network interface 110 is a wired interface (e.g., the interface pursuant to 802.3 standard of IEEE: The Institute of Electrical and Electronics Engineers or the interface of Power Line Communication: PLC) for connecting with a network. The network interface 110, however, may be a wireless interface (e.g., the interface pursuant to IEEE 802.11 standard). The nonvolatile memory 150 is a readable/writable flash memory. The nonvolatile memory 150, however, may be a different type of nonvolatile memory (e.g., a readable/writable memory including a hard disc drive or the like and a write inhibit memory such as a mask ROM [(Read Only Memory)] or the like). The display 160 is a liquid crystal display capable of displaying an image. The display 160, however, may be provided by a different type of display capable of displaying the image (e.g., an organic Electro-Luminescence display). The operating unit 162 includes a keyboard and a computer mouse. The operating unit 162, however, may be an input device (e.g., a touch panel) of a different type capable of detecting an operation by a user.

The control unit 120 is a computer comprising a CPU (central processing unit) 130 and a memory 140 (e.g., DRAM (Dynamic Random Access Memory)) temporarily storing various data. The control unit 120 controls each part of the communication device 100. By executing a program (not shown) stored in the nonvolatile memory 150, the CPU 130 realizes various functions as processing units (modules), including a virtual interface forming unit 132, a file system control unit 133, a relation display control unit 134, a display command transmission unit 135 and a user selection unit 136. The combination of the relation display control unit 134, the display command transmission unit 135 and the user selection unit 136 acts as a notification control unit (whose detail is described later). Hereinafter, execution of functions by CPU (e.g., the CPU 130) as a certain processing unit according to the program is also expressed as the execution of the processing by the processing unit.

The device server 200 includes a network interface 210, a control unit 220, a nonvolatile memory 250, a USB host controller 290, the four USB ports 291 to 294 and the four lamps 281 to 284. The network interface 210 is a wired interface (e.g., the interface pursuant to IEEE 802.3 standard or the interface of PLC) for connecting with a network. The network interface 210, however, may be a wireless interface (e.g., the interface pursuant to IEEE 802.11 standard).The nonvolatile memory 250 is a readable/writable flash memory. The nonvolatile memory 250, however, may be a different type of nonvolatile memory (e.g., a readable/writable memory such as a hard disc drive or the like and a write inhibit memory such as a mask ROM or the like).

The USB ports 291 to 294 are physical ports meeting the USB standard. The USB host controller 290 is one meeting the USB standard and controls the communication with the USB devices connected with the USB ports 291 to 294.

The USB ports 291 to 294 are preliminarily assigned identifiers different from one another. According to the present embodiment, the first USB port 291 is assigned “1” and the second, third and fourth USB ports are assigned “2”, “3” and “4”, respectively (hereinafter, the identifier of the USB port is referred to as “port number”). The host controller 290 can identify each USB port by utilizing this port number. Further, the USB host controller 290 assigns an identifier (otherwise referred to as “address”) different in each USB device to each of the USB devices mounted on (connected with) the USB ports. The USB host controller 290 utilizes this address to be capable of identifying communication other party. Thus, the USB host controller 290 corresponds to the USB interface and has the function to provide for use of a plurality of USB ports.

In addition, a mark showing the port number (more generally, referred to as a port identifier) is desirably put in the vicinity of the USB ports 291 to 294 on the surface of a case of the device server 200. Accordingly, by observing the mark, a user can identify the port numbers of the USB ports 291 to 294.

The control unit 220 is a computer including a CPU 230 and a memory 240 for temporarily storing various data. The control unit 220 controls each unit of the device server 200. By executing a program (not shown) stored in the nonvolatile memory 250, the CPU 230 realizes the functions of various processing units including an interface relay unit 232, a corresponding data transmission unit 233 and a lamp display control unit 238, which are described in more detail later.

Each of the lamps 281 to 284 is, e.g., a light emitting diode. The lamps 281 to 284 are each connected with a GPIO (General Purpose Input/Output) interface, not shown, of the CPU 230. As described below, the CPU 230 allows one of the lamps 281 to 284 to light in a different way than that of the other lamps and thus is capable of showing one USB port in a manner distinguishable from the other USB ports. In this manner, all the lamps are allowed to correspond to a port distinguishing display unit 280 for displaying one port selected from among a plurality of USB ports in a manner distinguishable from the other ports.

Next is a description of a file system control unit 133 and a virtual interface forming unit 132 of the communication device 100 and an interface relay unit 232 of the device server 200.

At the request from an application (e.g., a word processor) running on the communication device 100, the file system control unit 133 of the communication device 100 accesses a storage region (writes in data (if possible) and reads out data). The file system control unit 133 accesses the storage region via a device driver, not shown, for controlling a device providing the storage region. Further, the file system control unit 133 can handle a plurality of storage regions and assign an alphabetic identifier to each storage region. Such an identifier is called “drive letter”. Using the drive letter, a user can select the storage region accessed by the file system control unit 133. An expressive form of the identifier of the storage region is different depending on an operation system. The identifier of the storage region, e.g., may be expressed by a path name beginning with a route directory.

By communicating with the interface relay unit 232 of the device server 200 via the network 800, the virtual interface forming unit 132 of the communication device 100 forms a virtual USB interface 132i (e.g., the virtual interface forming unit 132 forms a virtual route hub (the USB host controller). The virtual USB interface 132i that has been formed corresponds to the USB interface (the host controller 290) of the device server 200. The virtual interface forming unit 132 performs data communication (data communication pursuant to the USB standard) with the USB device connected with the device server 200 via the interface relay unit 232 and the USB host controller 290. The virtual interface forming unit 132 and the interface relay unit 232 encapsulates the data communication pursuant to the USB standard using communication packets via the network 800.

The virtual interface forming unit 132 permits an application (e.g., a device driver for a USB device) running on the communication device 100 to access the virtual USB interface 132i. A method for accessing the virtual USB interface 132i is the same as that for accessing a normal USB interface (the USB host controller). As a result, it looks, from the application, as if the USB device connected with the device server 200 were connected directly with the virtual USB interface 132i of the communication device 100. According to the present embodiment shown in FIG. 2, for example, the file system control unit 133 of the communication device 100 recognizes that the first USB memory 301 and the second USB memory 302 are connected with the virtual USB interface 132i. Then, the file system control unit 133 assigns drive letters to the first USB memory 301 and the second USB memory 302.

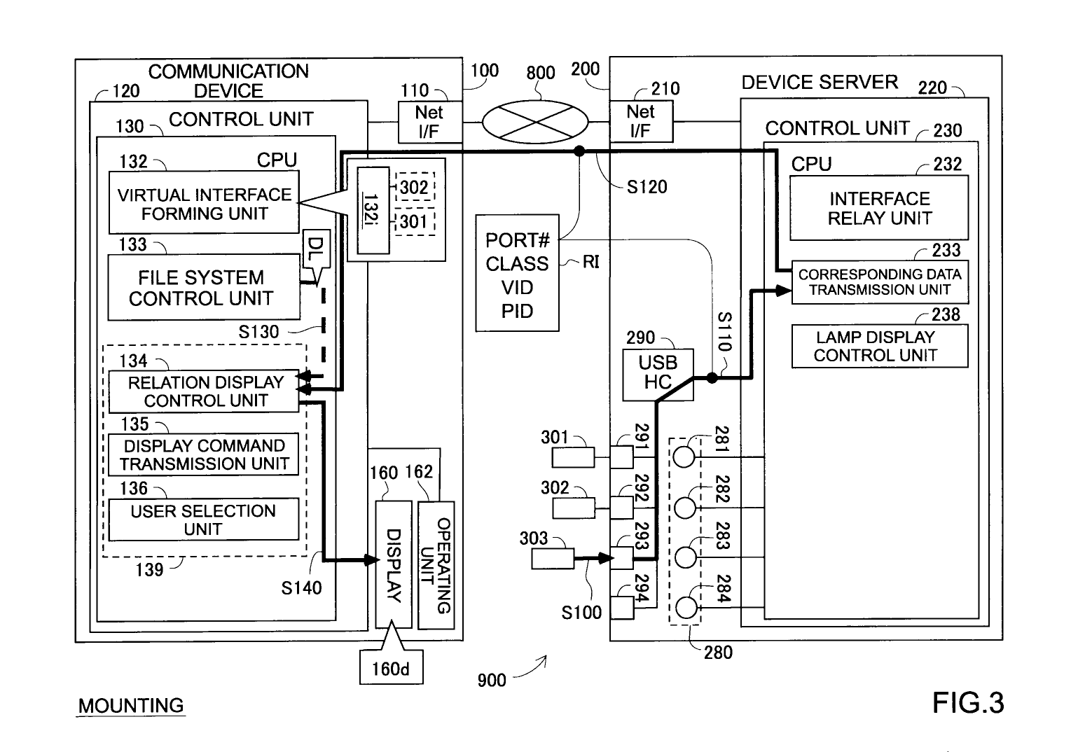

Next is a description of processing units 132 to 136 of the communication device 100 and processing units 232, 233. 238 of the device server 200 with reference to FIGS. 3 to 7.

FIG. 3 is a block diagram illustrating one example of the behavior of the system 900 according to the present embodiment, when the USB devices are mounted on (connected with) the USB ports 291 to 294 of the device server 200. In the block diagram in FIG. 3, the memories 140, 240 and the nonvolatile memories 150, 250 is omitted among the components of the communication device 100 and device server 200. The arrowed lines shown in FIG. 3 indicate a processing flow when the USB devices are mounted on (connected with) the USB ports 291 to 294 of the device server 200.

In the first step S100, a user mounts the third USB memory 303 on the third USB port 293 of the device server 200. In the next step S110, the host controller 290 detects the mounting of the third USB memory 303 to perform initializing process of the host controller 290. By the initializing process, the host controller 290 obtains a device descriptor from the third USB memory 303. The device descriptor includes a device class, a vender ID and a product ID. Then, the host controller 290 supplies information (hereinafter, referred to as “mounted device information RI”) for identifying the USB device mounted to a corresponding data transmission unit 233. According to the present embodiment, the mounted device information RI includes an identifying number (hereinafter, referred to as “port number”) of the USB port mounted on the USB device, the device class, the vender ID and the product ID. The device information RI may include other pieces of information (e.g., a letter string descriptor describing a manufacturer and a letter string descriptor describing a product). In addition, according to the present embodiment, a port number is used as device identifying information for identifying a USB device (the detail is described below).

In the next step S120, the corresponding data transmission unit 233 transmits the mounted device information RI to the relation display control unit 134 of the communication device 100.

In the next step S130, the relation display control unit 134 obtains the drive letter DL assigned from the file system control unit 133. The drive letter DL obtained is one assigned to a storage region of the USB memory which has been recognized to be connected with the virtual USB interface 132i. According to the present embodiment, e.g., the relation display control unit 134 obtains the drive letters assigned to the storage region of the two USB memories 301, 302 connected with the virtual interface 132i.

In the next step 140, the relation display control unit 134 allows the display unit 160 to display a management screen 160d on using the obtained information.

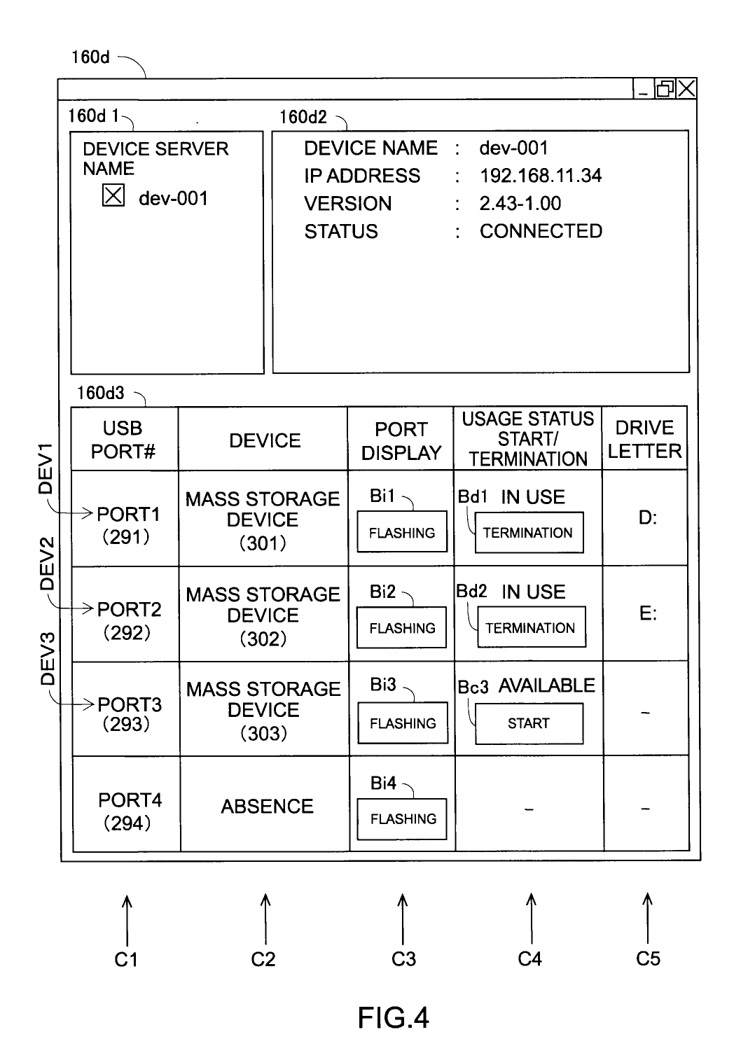

FIG. 4 is an explanatory drawing illustrating one example of the management screen 160d displayed on the communication device 100 according to the present embodiment. The management screen 160d includes a server name region 160d1, a server information region 160d2 and a device region 160d3. The server name region 160d1 displays a device server name (a host name of TCP/IP). According to the present embodiment, the server information region 160d1 displays the name of the device server 200 (FIG. 3). The server information region 160d2 displays detailed information on a device server (e.g., the device server 200). According to the present embodiment, the server information region 160d2 displays the name of the device server 200, an IP address, a version and an operating state. The device region 160d3 displays a table showing information on the USB port of the device server 200 and the USB device mounted on the USB port. According to the present embodiment, the device region 160d3 displays a correspondence relation among a port number (the first column C1), a type of device (the second column C2), a port indicating button (the third column C3), a status of use (the fourth column C4) and a drive letter (the fifth column C5).

The port number (the first column C1) is the port number of the USB port. A symbol within parentheses shows the symbol of the corresponding USB port. This symbol is shown for the convenience of explanation and therefore is not shown in practice.

The type of device (the second column C2) is a type of a USB device identified by the mounted device information RI. The type displayed may be, e.g., a type indentified by a device class. Instead of the type, the type displayed may be a type identified by the combination of a vender IP and a product ID and further may be the information shown by a letter string descriptor. According to the present embodiment, it is shown that in the device region 160d3, “mass-storage devices” are mounted on each of the first to third ports 291 to 293 and no USB device is mounted on the fourth port 294. The symbol within the parentheses shows a symbol the corresponding USB device. This symbol is shown for the convenience of explanation and is not shown in practice.

The port indicating buttons Bi1 to Bi4 are described later.

The status of use (the fourth column C4) shows whether the USB device is in use or not. The fourth column C4 further displays buttons for terminating the use of the USB device for the USB device in use and displays buttons for starting the use of USB device for USB device not in use. Details of these buttons are described later.

When a USB device in use is a device for providing a storage region, the drive letter (the fifth column C5) is a drive letter assigned to the storage region.

According to the present embodiment, the USB device (the first USB memory 301) mounted on the first USB port 291 and the USB device (the second USB memory 302) mounted on the first USB port 292 are in use. The drive letter in the storage region of the first USB port 291 is “D”, while the drive letter in the storage region of the first USB port 292 is “E”. The device (the third USB memory 303) mounted on the third USB port 293 is in no use. In the fourth column C4, the first termination button Bd1 is displayed for the first USB port 291 and the second termination button Bd2 is displayed for the second USB port 292 and further the start button Bc3 is displayed for the third USB port 293.

In addition, each of the processing units 132 to 136, 232, 233, 238 including the relation display control unit 134 uses device identifying information in order to identify USB devices mounted on the device server 200. According to the present embodiment, the first USB memory 301 is identified by a first device identifying information DEV1, the second USB memory 302 is identified by a second device identifying information DEV2 and the third USB memory 303 is identified by a third device identifying information DEV3. According to the present embodiment, the device identifying information is the port number of a USB port. Such device identifying information is used in various processes described below.

Besides, the relation display control unit 134 may display a management screen 160d at an arbitrary timing. The relation display control unit 134, e.g., may automatically display the management screen 160d in response to the mounting of the USB device on the device server 200. Otherwise, the relation display control unit 134 may display the management screen 160d upon the request of a user. In any case, the relation display control unit 134 desirably updates automatically the contents of the management screen 160d in response to a change in displayed item. For example, when the communication device 100 starts to use a USB device and when the communication device 100 terminates the use of the USB device, the relation display control unit 134 desirably updates automatically the contents of the management screen 160d.

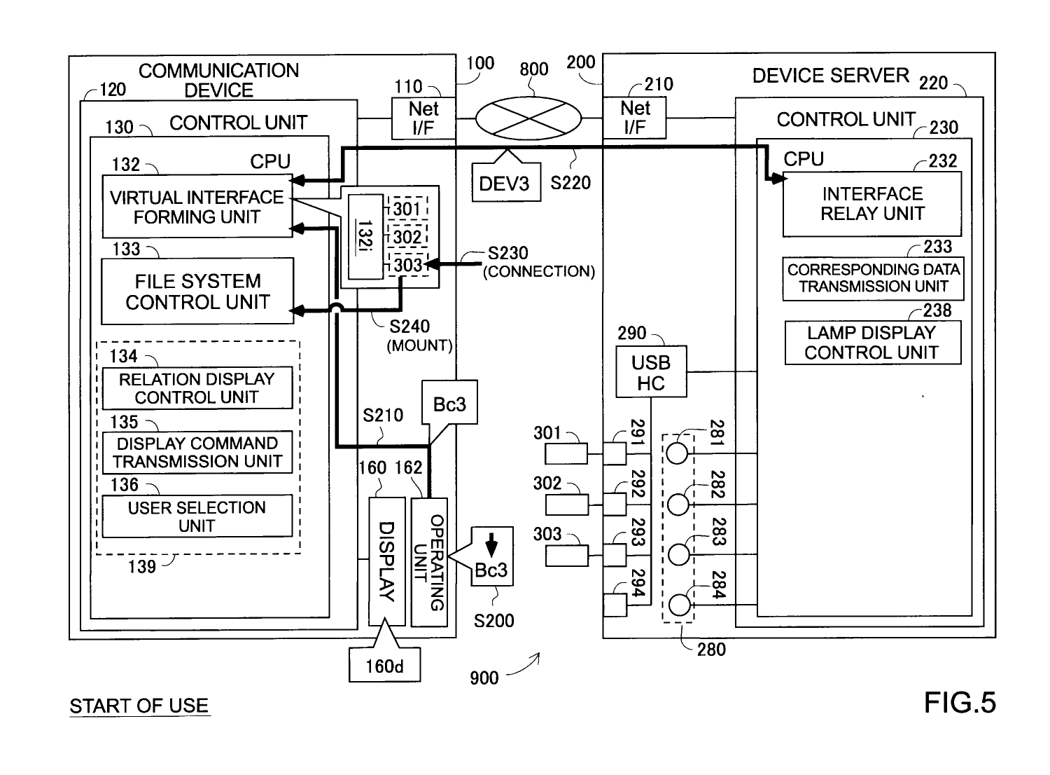

FIG. 5 is a block diagram illustrating one example of the behavior of the system 900 in the first embodiment when the start button Bc3 in FIG. 4 is operated. The configuration of the block diagram in FIG. 5 is the same as that in FIG, 3. The arrow lines shown in FIG. 5 indicate a process flow when the start button in FIG. 4 is operated.

In the first step S200, a user operates the start button Bc3 (in FIG. 4) by operating the operating unit 162. In the next step S210, the virtual interface forming unit 132 detects that the start button has been operated. The virtual interface forming unit 132 operates in cooperation with the relation display control unit 134 and therefore recognizes that the operation of the start button Bc3 is indicating that the device (the third USB memory 303) mounted on the third USB port 293 has been brought into use.

In the next step S220, the virtual interface forming unit 132 starts to use the third USB memory 303 by communicating with the interface relay unit 232 of the device server 200. At this case, the virtual interface forming unit 132 supplies the third device identifying information DEV3 for identifying the third USB memory 303 to the interface relay unit 232. The interface relay unit 232 starts to relay the communication between the third USB memory 303 identified by the third device identifying information DEV3 received and the virtual interface forming unit 132. Then, in the next step S230, the virtual interface forming unit 132 realizes a virtual state in which the third USB memory 303 is mounted on (connected with) the virtual USB interface 132i. As a result, the communication device 100 becomes capable of using the storage region of the third USB memory 303.

In the next step S240, the file system control unit 133 assigns a drive letter to the storage region of the third USB memory 303 and then adds the storage region to an accessing object (such a process is referred to as “mount process” in some cases).

By the above process, the communication device 100 starts to use the third USB memory 303 mounted on the device server 200.

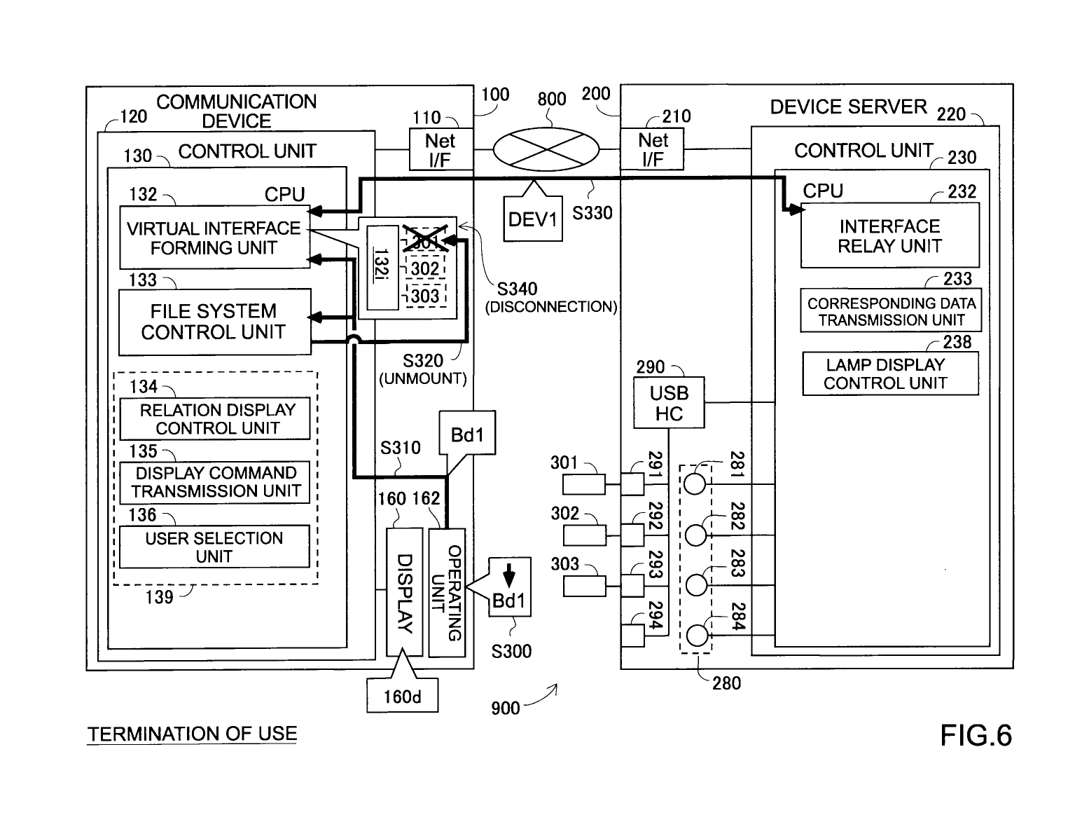

FIG. 6 is a block diagram illustrating one example of the behavior of the system 900 in the first embodiment when a termination button Bd1 in FIG. 4 is operated. The configuration of the block diagram in FIG. 6 is the same as that in FIG. 3. The arrow lines in FIG. 6 indicate a process flow when the termination button Bd1 in FIG. 4 is operated.

In the first step S300, by operating the operating unit 162, a user operates the termination button Bd1 (in FIG. 4). In the next step S310, the virtual interface forming unit 132 and the file system control unit 133 detects that the termination button Bd1 is operated. The virtual interface forming unit 132 and the file system control unit 133 operate in cooperation with the relation display control unit 134 and therefore recognize that the operation of the termination button Bd1 indicates that the use of the device (the first USB memory 301) mounted on the first USB port 291 has been terminated.

In the next step S320, the file system control unit 133 terminates the access to the storage region of the first USB memory 301 to delete the storage region from the access object (such a process is also referred to as “unmount process”).

In the next step S330, the virtual interface forming unit 132 communicates with the interface relay unit 232 to thereby terminate the use of the first USB memory 301. In this case, the virtual interface forming unit 132 supplies the first device identifying information DEV1 for identifying the first USB memory 301 to the interface relay unit 232. The interface relay unit 232 terminates the relay of the communication between the first USB memory 301 identified by the first device identifying information DEV1 received and the virtual interface forming unit 132. In the next step S340, the virtual interface forming unit 132 realizes a virtual state in which the virtual USB interface 132i and the first USB memory 301 are disconnected. As a result, the communication device 100 becomes unable to use the storage region of the first USB memory 301.

By the above process, the communication device 100 terminates the use of the first USB memory 301 mounted on the device server 200. A user can remove the first USB memory 301. A plurality of the USB devices of the same type, however, is mounted on the device server 200 (in FIG. 1, FIG. 4). Accordingly, it is, however, likely to be difficult for a user to identify a USB device to be removed. Therefore, according to the present embodiment, the port distinguishing display unit 280 (in FIG. 1, FIG. 2) displays the USB port connected with the USB device selected by the user in a manner distinguishable from the other USB ports.

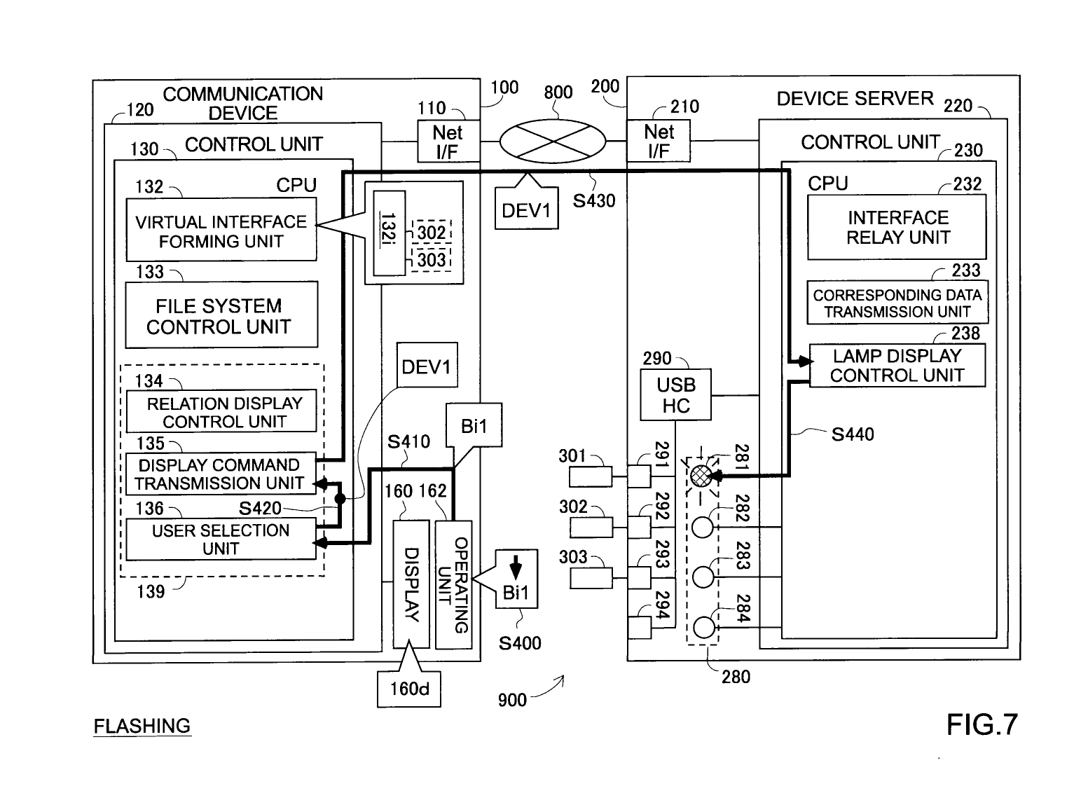

FIG. 7 is a block diagram illustrating one example of the behavior of the system 900 in the first embodiment when a port indicating button Bi1 in FIG. 4 is operated. The configuration of the block diagram in FIG. 7 is the same as that in FIG. 3. The arrow lines shown in FIG. 7 indicate a process flow when the port indicating button Bi1 in FIG. 4 is operated. By this process, the port distinguishing display unit 280 displays one USB port in a manner distinguishable from the other USB ports. In addition, as shown in FIG. 4, according to the present embodiment, regardless of whether a USB device is in use or not, the relation display control unit 134 displays the port indicating buttons of all the USB ports 291 to 294 (the first port indicating button Bi1 corresponds to the first USB port 291, the second port indicating button Bi2 corresponds to the second USB port 292, the third port indicating button Bi3 corresponds to the third USB port 293, and the fourth port indicating button Bi4 corresponds to the fourth USB port 294). Accordingly, the communication device 100 terminates the use of the first USB memory 301 by the process shown in FIG. 6 and thereafter a user can operate the port indicating button Bi1 associated with the first USB memory 301 brought to the end of the use.

In the first step S400, a user operates a port indicating button Bi1 (in FIG. 4) by operating the operating unit 162. In the next step S410, the user selection unit 136 detects that the port indicating button Bi1 has been operated. The user selection unit 136 operates in cooperation with the relation display control unit 134 to thereby recognize that the operation of the port indicating button provides the indication of the first USB port 291 in a manner distinguishable from the other ports.

In the next step S420, the user selection unit 136 supplies the first device identifying information DEV1 for identifying the first USB port 291 (the first USB memory 301) selected to the display command transmission unit 135. In the next step S430, the display command transmission unit 135 transmits the command including the first device identifying information DEV1 to the lamp display control unit 238. This command is one for flashing the lamp associated with a USB port (here, the USB port 291) related to the device identifying information (here, the first device identifying information DEV1). Hereinafter, this command is referred to as a distinction display command.

In the next step S440, the lamp display control unit 238 flashes the first lamp 281 associated with the first USB port 291 related to the first device identifying information DEV1. The lamp display control unit 238 keeps the other lamps 282 to 284 unlit. As a result, by observing the first lamp 281 that is flashing, a user can easily learn that a USB device to be removed is the first USB memory 301 mounted on the first USB port 291. As a result, a user is allowed to become less likely to remove the wrong USB memory.

As described above, according to the present embodiment, as shown in FIG. 4, the relation display control unit 134 displays, on the display 160, the correspondence relation of a plurality of items including a USB port (an identifier of the USB port) and a USB device (a type of the device). As a result, by means of the USB port, a user can easily distinguish one arbitrary USB device among a plurality of USB devices from the other USB devices. Further, the correspondence relation displayed includes an identifier (a drive letter) of a storage region. As a result, with the identifier of the storage region provided as a clue, a specific USB device can be easily distinguished from the other USB devices.

Further, as shown in FIG. 7, the lamp display control unit 238 allows the port distinguishing display unit 280 to display a USB port connected with a specific USB device in a manner distinguishable from the other ports (S440). As a result, a user can easily check with which USB port a specific USB device is connected.

Here, using device identifying information (here, the first device identifying information DEV1) reflecting a result selected by a user, the display command transmission unit 135 transmits, to the display lamp control unit 238, the distinction display command for displaying the port with which the USB device selected by the user is connected (S430). Accordingly, the port distinguishing display unit 280 displays the port mounted with the USB device selected by the user (S440). As a result, a user can easily distinguish a desired USB device from the other USB devices.

Besides, as shown in FIG. 4, the management screen 160d displays a button (e.g., the port display button Bi1) for selecting a USB device and a drive letter in association with each other. Accordingly, a user can easily select the USB device associated with a specific drive letter.

In addition, according to the present embodiment, both the display of the management screen 160d (device region 160d3) shown in FIG. 4 and the display by the port distinguishing display unit 280 shown in FIG. 7 correspond to the notification of a correspondence relation (the correspondence relation between a USB device and the port connected with the USB device). In this way, according to the present embodiment, the notification control unit 139 of the communication device 100 performs the notification of a correspondence relation in two types.

### Second Embodiment

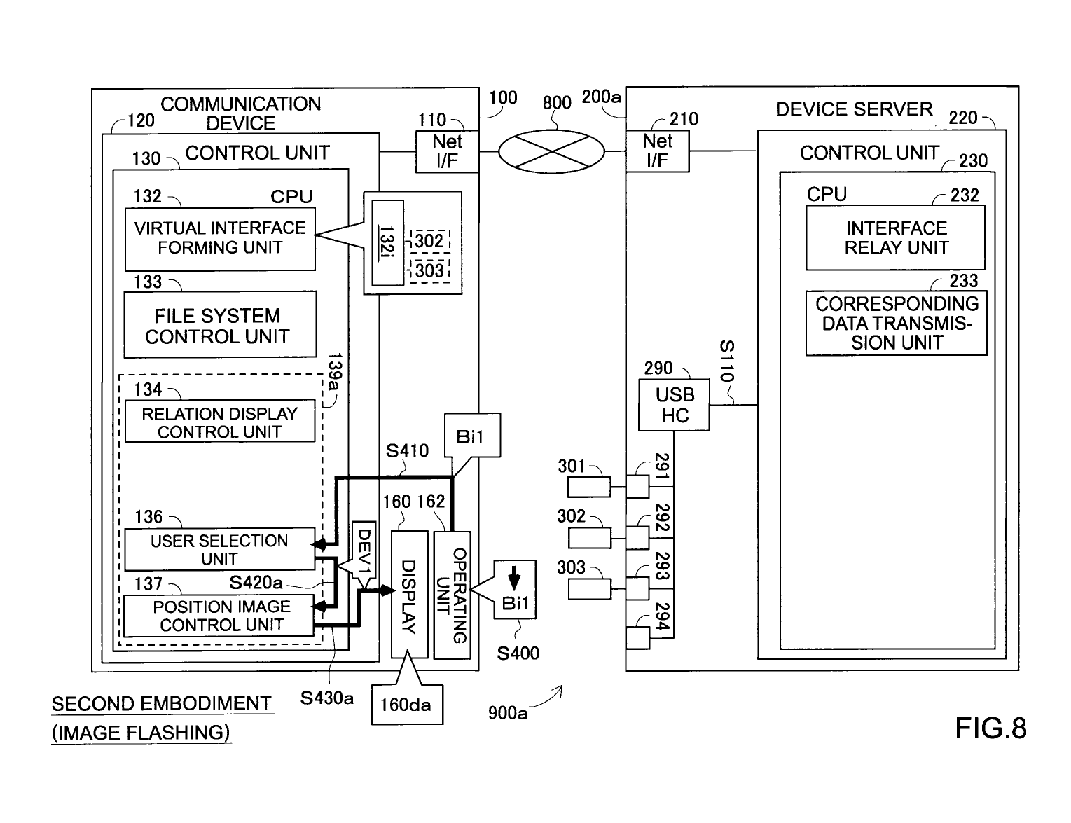

FIG. 8 is a block diagram illustrating one example of the behavior of the communication system 900a according to the second embodiment of the present invention. The difference between the hardware configuration of the system 900a and that of the system 900 shown in FIG. 2 is only that the port distinguishing display unit 280 is omitted in the device server system 220a of the system 900a. Further, in the system 900a, differing from the system 900 in FIG. 2, the lamp display control unit 238 of the device server 200 and the display command transmission unit 135 of the communication device 100 are omitted. Instead of these omitted units, the CPU 130 of the communication device 100 realizes the function of a position image control unit 137. The combination of the relation display control unit 134, the user selection unit 136 and the position image control unit 137 acts as a notification control unit 139a. In addition, in the block diagram in FIG. 8, as is the case with the block diagram in FIG. 3, the memories 140, 240 and the nonvolatile memories 150, 250 is not shown.

The system 900a according to the second embodiment executes the same process as that in FIG. 3 to FIG. 6 in the first embodiment. Besides, the system 900a according to the second embodiment executes a process in FIG. 8 instead of the process in FIG. 7 in the first embodiment. The arrow lines in FIG. 8 are a process flow when the port display button Bi1 in FIG. 4 is operated.

Steps S400, S410 are the same as the steps S400, S410 in FIG. 7, respectively. By these steps S400, S410, the user selection unit 136 detects that the port display button Bi1 has been operated.

In the next step S420a, the user selection unit 136 supplies, to the position image control unit 137, the first device identifying information DEV1 for identifying the first USB port 291 (the first USB memory 301) associated with the port display button Bi1. In the next step S430a, the position image control unit 137 allows the display unit 160 to display an image showing a physical positional relationship of the USB port of the device server 200.

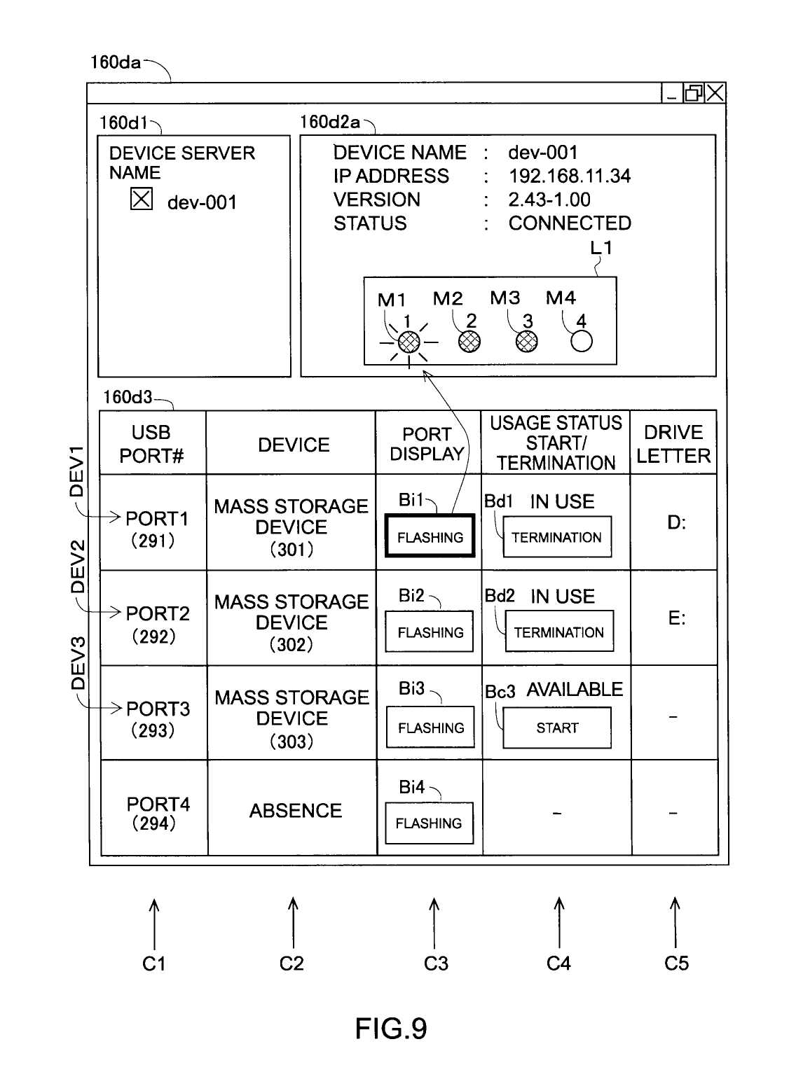

FIG. 9 is an explanatory drawing illustrating a management screen 160da displayed on the display unit 160 of the communication device 100 according to the second embodiment. The difference between the management screen 160da and the management screen 160d shown in FIG. 4 is only a point that a position image L1 is added to a server information region 160d2a. The position image control unit 137 adds the position image L1 to the server information region 160d2a of the management screen 160d (in FIG. 3, FIG. 4) displayed on the display unit 160 by the relation display control unit 134. Alternatively, the position image control unit 137 may allow the display unit 160 to display the whole of the management screen 160da as does the relation display control unit 134.

The position image L1 displays four lamp images M1 to M4 indicating the physical positional relationship of the four USB ports 291 to 294 (in FIG. 1). The physical positional relationship of these lamp images M1 to M4 is the same as that of the USB ports 291 to 294. Specifically, the lamp images M1 to M4 are laid out in a line as are the USB ports 291 to 294. The positional relationship is the same in this manner and therefore a user can easily recognize that the four lamp images M1 to M4 are associated with the four USB ports 291 to 294. The leftmost first lamp image M1, e.g., corresponds to the leftmost first USB port 291. In addition, the position image L1 in FIG. 9 displays a number representing a port number in the vicinity of the lamp images M1 to M4. The display of the port number, however, may be omitted.

Further, the position image control unit 137 displays the lamp image associated with a USB port related to the device identifying information in a different form from that of the other lamp images. In the preset embodiment, the position image control unit 137 flashes the first lamp image M1 related to the first device identifying information DEV1. The position image control unit 137 displays the other lamp images M2 to M4 by means of a lighted image or an unlit image. The position image control unit 137 displays the lamp image of the USB port mounted with the USB device by means of a lighted image and the USB port not mounted therewith by means of an unlit image.

A user who has observed the position image L 1 described above can easily learn that the USB device (the first USB memory 301) selected by the user is mounted on (connected with) the USB port identified by the flashing lamp image (the first lamp image M1).

In addition, according to the present embodiment, both the display of the device region 160d3 and the display of the position image L1 correspond to the notification of a correspondence relation (the correspondence relation between the USB device and the port connected with the USB device) (in FIG. 9). In this manner, according to the present embodiment, the notification control unit 139a (in FIG. 8) of the communication device 100 performs the notification of a correspondence relation in the two forms.

### Third Embodiment

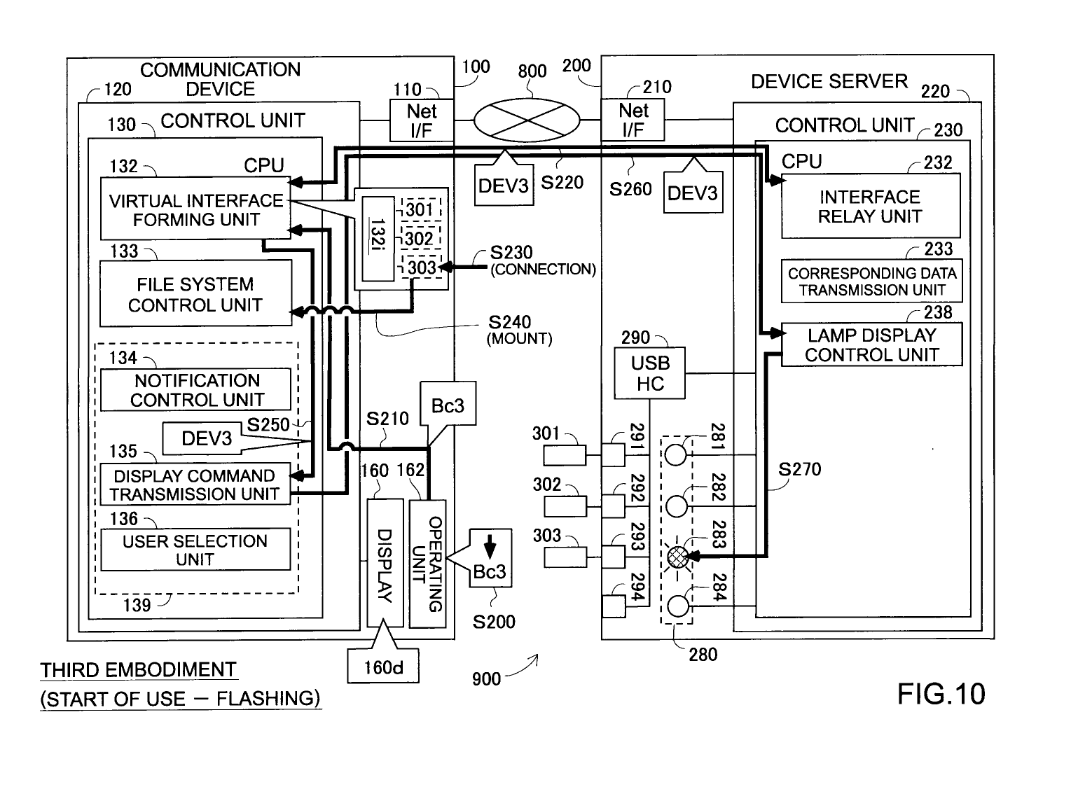

FIG. 10 is a block diagram illustrating one example of the behavior of the communication system 900 in a third embodiment of the present invention. The configuration of the block diagram in FIG. 10 is the same as that in FIG. 5. A process flow indicated by the arrow lines is produced by adding the process steps S250, S260, S270 in FIG. 5.

As described in FIG. 5, by means of the process of the steps 200 to 240, the communication device 100 starts to use the third USB memory 303 selected by a user. In response to the start, in the next step S250, the display command transmission unit 135 obtains, from the virtual interface forming unit 132, device identifying information (the third device identifying information DEV3) for identifying a USB device brought into use. In the next step S260, the display command transmission unit 135 transmits, to the lamp display control unit 238, the distinction display command including the device identifying information (the third device identifying information DEV3) obtained. The process in this step S260 is the same as that in the step S430 in FIG. 7. In the next step S270, according to the distinction display command, the lamp display control unit 238 flashes the third lamp 283 associated with the third USB port 293 related to the third device identifying information DEV3. The process in this step 270 is the same as that in the step S440 in FIG. 7 (The flashing of a lamp corresponds to the notification of a correspondence relationship (the correspondence relationship between a USB device and the port connected with the USB device)).

As described above, in the process according to the present embodiment, the display command transmission unit 135 transmits, to the lamp display control unit 238, the distinction display command for identifying the USB device selected to be used by the communication device 100. As a result, a user can easily check with which port the USB device selected for use is connected. The user, e.g., can easily check whether the USB device brought into use is a desired one or not. In addition, the display command transmission unit 135 may obtain, from the operating unit 162 instead of the virtual interface forming unit 132, the device identifying information for identifying the USB device selected for use. Further, the process in FIG. 10 is applicable to the system 900a according to the second embodiment shown in FIG. 8 and FIG. 9.

In addition, in the step S210, the operating unit 162 may notifies the fact that the start button is operated (that a USB device is selected for use by a user) to the display command transmission unit 135 in addition to the virtual interface forming unit 132. Then, the display command transmission unit 135 may execute the step S260 in response to this notification regardless of whether a USB device has been brought into use or not. Besides, the display command transmission unit 135 may execute the step S260 in response to the fact that the USB device is brought into use by the communication device 100.

### Fourth Embodiment

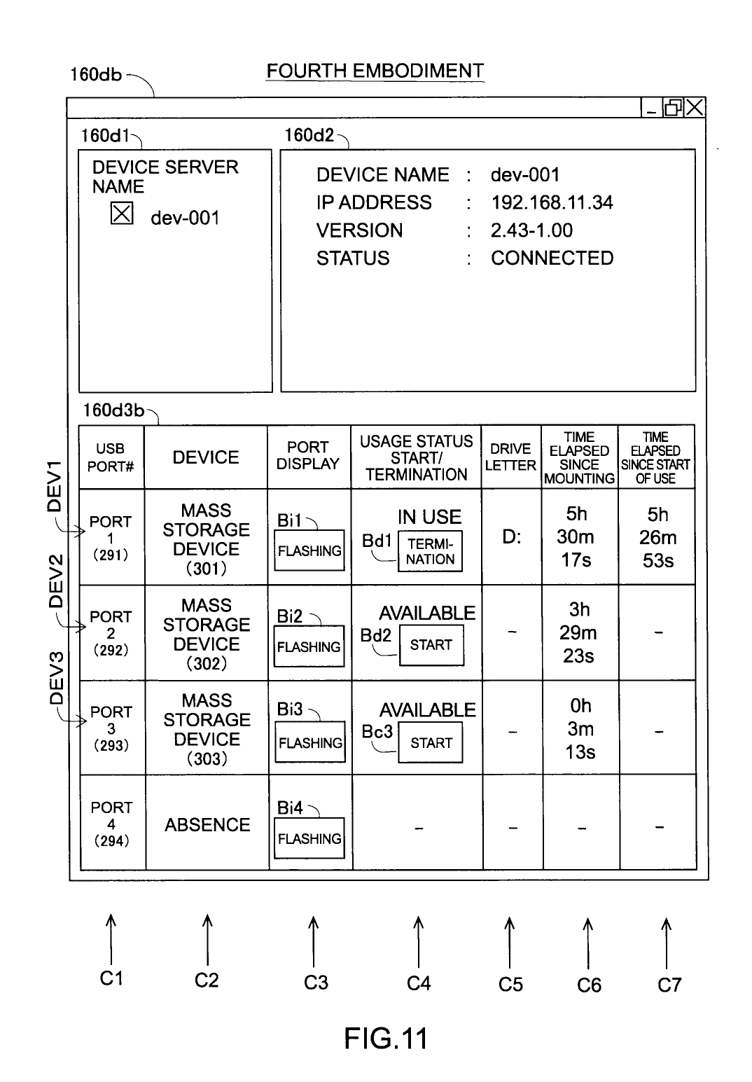

FIG. 11 is an explanatory drawing illustrating one example of a management screen displayed on the display unit 160 of the communication device 100 in a fourth embodiment of the present invention. The difference between the management screen 160db in the fourth embodiment shown in FIG. 11 and the management screen 160d in the first embodiment shown in FIG. 4 is that in the management screen 160db according to the present embodiment, the correspondence relation shown by the device region 160d3b includes “time elapsed since mounting (connection) (a sixth column C6)” and “time elapsed since the start of use (a seventh column C7)”. “The time elapsed since mounting (connection) (a sixth column C6)” shows a time elapsed since a USB device has been mounted on (connected with) a USB port. “The time elapsed since the start of use (a seventh column C7)” shows a time elapsed since the communication device 100 started to be used use a USB device. According to the present embodiment, both the elapsed times are expressed in “hour, minute and second”.

Instead of the management screen 160d in the first embodiment, the relation display control unit 134 (in FIG. 2 and FIG. 8) displays the management screen 160db according to the present embodiment, on the display unit 160. The relation display control unit 134 obtains these elapsed times as part of the mounted device information RI from the corresponding data transmission unit 233 of the device server 200. The control unit 220 of the device server 200 has a timer, not shown, and measures each elapsed time using the timer.

In this manner, the correspondence relation displayed by the management screen 160db includes “the time elapsed since mounting (connection) (the sixth column C6)” and therefore a user can check the time at which each USB device has been mounted. As a result, the user can distinguish a specific USB device from the other USB devices with the mounted timing of the USB device provided as a clue. The user, e.g., mounts a USB device on the USB port of the device server 200 to use the USB device. In the management screen 160db displayed immediately after the mounting, “the time elapsed since the mounting” of the USB device mounted by the user is shortest. In the displayed example in FIG. 11, e.g., the second and third USB memories 302, 303 are not in use. Observing the sixth column C6, the elapsed time of the third USB memory 303 is shorter than that of the USB memory 302. Accordingly, the user can easily check that the USB device that has been mounted on the device server 200 is mounted on the third port 293. Then, by operating a start button Bc3 associated with the third USB port 293, the user can start to use the desired USB device.

Further, according to the present embodiment, the correspondence relation shown by the management screen 160db includes “the time elapsed since the start of use (the seventh column C7)” and therefore the user can check the time at which each USB device has been brought into use. As a result, the user can distinguish a specific USB device from the other USB devices with the time elapsed since the start of use provided as a clue. The user, e.g., terminates the USB device which has been used over a prolonged period of time in same cases. In this case, the user may search the correspondence relation in which an elapsed time is long in the seventh column C7. Then, by operating the termination button (e.g., the termination button Bd1) in the correspondence relation found by the search, the user can select an appropriate USB device.

### Fifth Embodiment

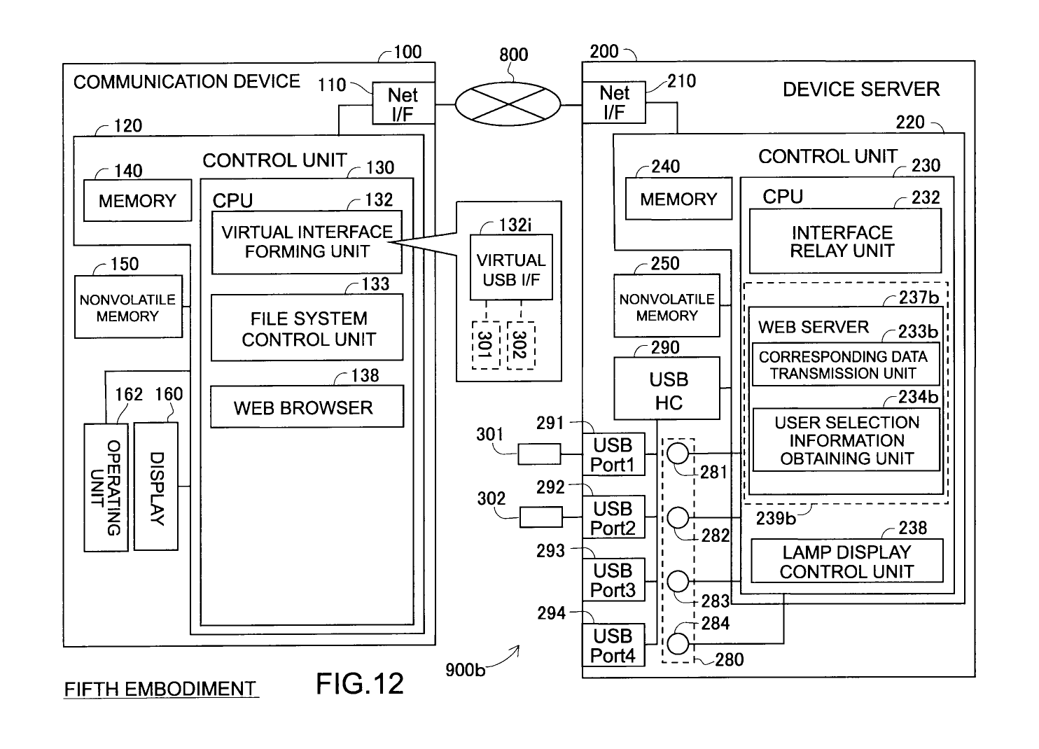

FIG. 12 is a block diagram illustrating the configuration of a communication system 900b in a fifth embodiment of the present invention. The hardware configuration of a communication system 900b according to the present embodiment, is the same as that of the communication system 900 in the first embodiment shown in FIG. 2. According to the present embodiment, however, the content of the process executed by the CPU 130 of the communication device 100 and the content of the process executed by the CPU 230 of the device server 200 differ from that in the first embodiment (in, e.g., FIG. 2). According to the present embodiment, the device server 200 acts as a web server for providing a web page displaying a management screen (e.g., the management screen 160d in FIG. 4). At the same time, the communication device 100 acts as a browser for displaying a web page. Specifically, the CPU 230 of the device server 200 realizes the function of the web server 237b, instead of the function of the corresponding data transmission unit 233 (in FIG. 2) in the first embodiment. The web server 237b includes a corresponding data transmission unit 233b and a user selection information obtaining unit 234b. In addition, the web server 237b functions as a correspondence relation output unit 239b. The CPU 130 of the communication device 100 realizes the function of a general-purpose web browser 138 instead of the functions of the relation display control unit 134, the display command transmission unit 135 and the user selection unit 136 in the first embodiment (in FIG. 2)

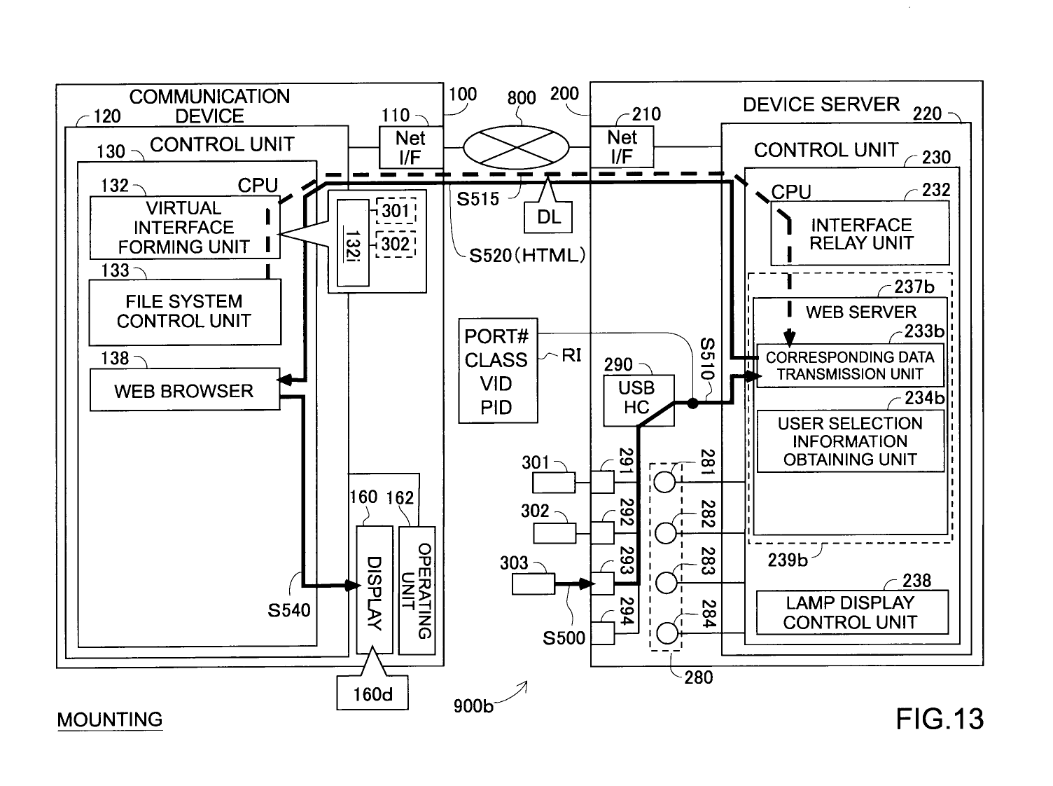

FIG. 13 is a block diagram illustrating one example of the behavior of the communication system 900b according to the present embodiment, of the present invention when USB devices are mounted on (connected with) the USB ports 291 to 294 of the deice server 200. In the block diagram in FIG. 13, the memories 140, 240 and the nonvolatile memories 150, 250 are omitted from among the components of the communication device 100 and the device server 200. The arrowed lines shown in FIG. 13 indicate a process flow when USB devices are mounted on (connected with) the USB ports 291 to 294 of the deice server 200.

Steps S500, S510 are the same as the steps S100, S110 in the first embodiment shown in FIG. 3, respectively. Through the steps S500, S510, the corresponding data transmission unit 233b obtains mounted device information RI.

In the next step S515, the corresponding data transmission unit 233b obtains a drive letter DL that has been assigned from the interface relay unit 232. The drive letter DL obtained is the same as the drive letter DL obtained through the step S130 in the first embodiment shown in FIG. 3. The interface relay unit 232 obtains a drive letter DL from the virtual interface forming unit 132 of the communication device 100. The virtual interface forming unit 132 obtains a drive letter DL from the file system control unit 133. In addition, the corresponding data transmission unit 233b may obtain the drive letter DL directly from the communication device 100 not via the interface relay unit 232. The corresponding data transmission unit 233b, e.g., may obtain the drive letter DL from the file system control unit 133.

In the next step S520, the web browser 138 of the communication device 100 requests a web data page for showing a web page to the device server 200. The web browser 138 requests data in response to the instruction of a user. The corresponding data transmission unit 233b transmits, to the web browser 138, the web page data showing the management screen 160d (in FIG. 4) at the request. In addition, the web page data, e.g., include HTML data described in HTML (HyperText Markup Language) and image data linked to the HTML data.

In the next step S540, the web browser 138 allows the display unit 160 to display the management screen 160d (in FIG. 4) the same as that in the first embodiment, based on the web page data received.

As shown in FIG. 4, the management screen 160d can include a start button (e.g., the start button Bc3) and a termination button (e.g., the termination button Bd1). When a user operates these buttons, the system 900b (in FIG. 12) executes a process in the same way the processes are done in FIG. 5, FIG. 6 in the first embodiment.

Specifically, by operating the operating unit 162, a user can operate a button displayed on the management screen 160d. The web browser 138 detects that the button has been operated by the user. Continuously, the web browser 138 notifies, to the user selection information obtaining unit 234b, which button has been operated. The user selection information obtaining unit 234b operates in cooperation with the corresponding data transmission unit 233b and therefore can identify a corresponding port number (a USB device) and a process to be executed. The user selection information obtaining unit 234b supplies a command to the interface relay unit 232 depending on the button operated. When the start button Bc3 has been operated, e.g., the user selection information obtaining unit 234b supplies, to the interface relay unit 232, a command to start to use the third USB memory 303 mounted on the USB third port 293. When the termination button Bd1 has been operated, the user selection information obtaining unit 234b supplies, to the interface relay unit 232, a command to terminate the use of the first USB memory 301 mounted on the first USB port 291. The interface relay unit 232 communicates with the virtual interface forming unit 132 of the communication device 100 and thus executes the process depending on the command received (the same as the steps S220, S230 in FIG. 5 in the first embodiment and the steps S330, S340 in FIG. 6). Accordingly, the system 900b executes the start of the use of a USB device and the termination of the use of the USB device in the same way the processes in FIG. 5, FIG. 6 in the first embodiment are done.

Further, as shown in FIG. 4, the management screen 160d includes the port display buttons Bi1 to Bi4. Next is a description of a process performed when a user has operated these buttons.

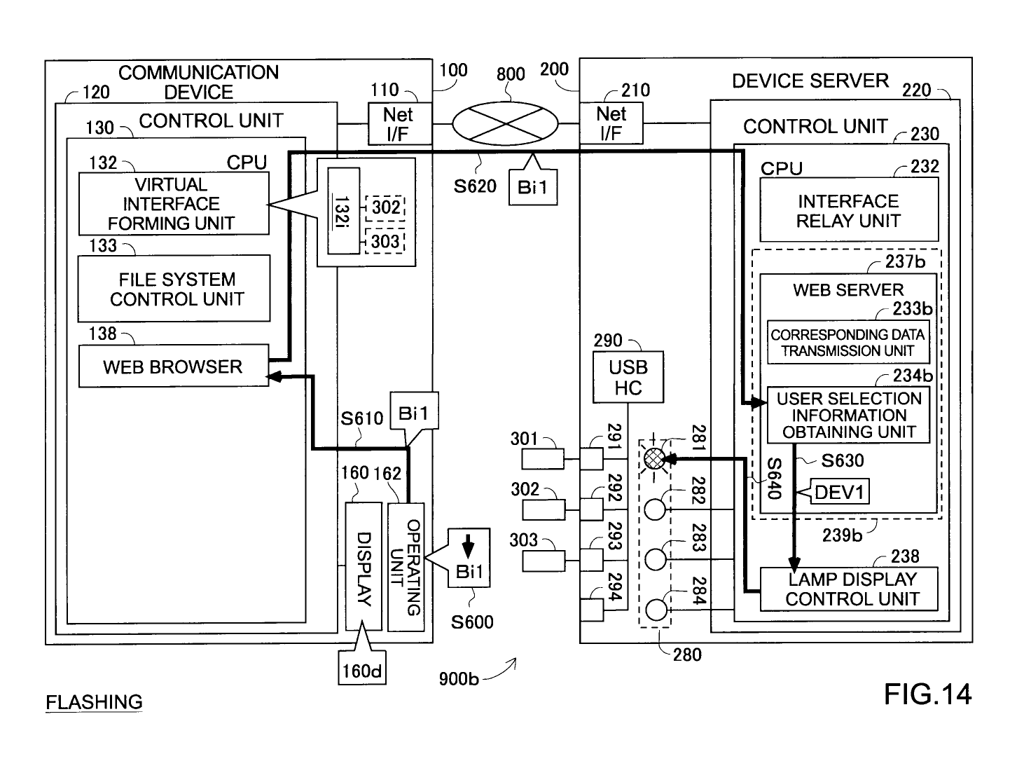

FIG. 14 is a block diagram illustrating another example of the behavior of the system 900b according to the present embodiment, when the port display button Bi1 in FIG. 4 has been operated. The configuration of the block diagram in FIG. 4 is the same as that in FIG. 13. Arrowed lines in FIG. 14 indicate a process flow when the port display button Bi1 in FIG. 4 has been operated.

In the first step S600, by operating the operating unit 162, a user operates the port display button Bi1 (in FIG. 4). In the next step S610, the web browser 138 detects that the port display button Bi1 has been operated. In the next step S620, the web browser 138 notifies which button has been operated to the user selection information obtaining unit 234b (here, the port display button Bi1). This notification corresponds to the demand of the display from the communication device 100. In the next step S630, the user selection information obtaining unit 234b supplies, to the lamp display control unit 238, device identifying information (here, the first device identifying information DEV1) related to the button operated. In the next step S640, the lamp display control unit 238 flashes the first lamp 281 associated with the first USB port 291 related to the first device identifying information DEV1. The process in the step S640 is the same as that in the step S440 in the first embodiment shown in FIG. 7.

As described above, according to the present embodiment, as is the case with the first embodiment, the communication device 100 displays the management screen 160d on the display unit 160 (in FIG. 13). As a result, the system 900b according to the present embodiment has the same advantages as the various advantages of the system 900 in the first embodiment. As in the first embodiment, e.g., by means of a USB port, a user can easily distinguish an arbitrary USB device among a plurality of USB devices from the other USB devices. Further, the user can easily distinguish a specific USB device from the other USB devices with an identifier (e.g., a drive letter) of a storage region provided as a clue.

Besides, as shown in FIG. 14, the lamp display control unit 238 allows the port distinguishing display unit 280 to display a specific USB port in a manner distinguishable from the other USB ports depending on the device identifying information from the user selection information obtaining unit 234b. As a result, the user can easily check with which USB port the specific USB device is connected.

Here, the user selection information obtaining unit 234b supplies, to the lamp display control unit 238, the device identifying information (e.g., the first device identifying information DEV1) reflecting the selection result by the user (S630). The lamp display control unit 238 performs the display of indicating the port on which the USB device selected by the user is mounted (S640). As a result, the user can easily distinguish a desired USB device from the other USB devices.

Further, as shown in FIG. 4, the management screen 160d displays a button to select the USB device (e.g., the port display button Bi1) and a drive letter in association with each other. Accordingly, the user can easily select the USB device associated with a specific drive letter.

Furthermore, according to the present embodiment, the of the web server 237b of the device server 200 executes a process corresponding to the process of the dedicated processing unit (the relation display control unit 134, the display command transmission unit 135 and the user selection unit 136) in the first embodiment shown in FIG. 2. Accordingly, the communication device 100 need not have an exclusive processing unit and can execute various processes using a general-purpose web browser 138. This holds true for a sixth embodiment and a seventh embodiment which are described below.

In addition, according to the present embodiment, both the display of the management screen 160d (the device region 160d3 in FIG. 4) and the display by the port distinguishing display unit 280 shown in FIG. 14 correspond to the notification of a correspondence relation (the correspondence relation between a USB device and a port connected with the USB device). In this manner, according to the present embodiment, the correspondence relation output unit 239b of the device server 200 executes the notification of a correspondence relation in two types.

### Sixth Embodiment

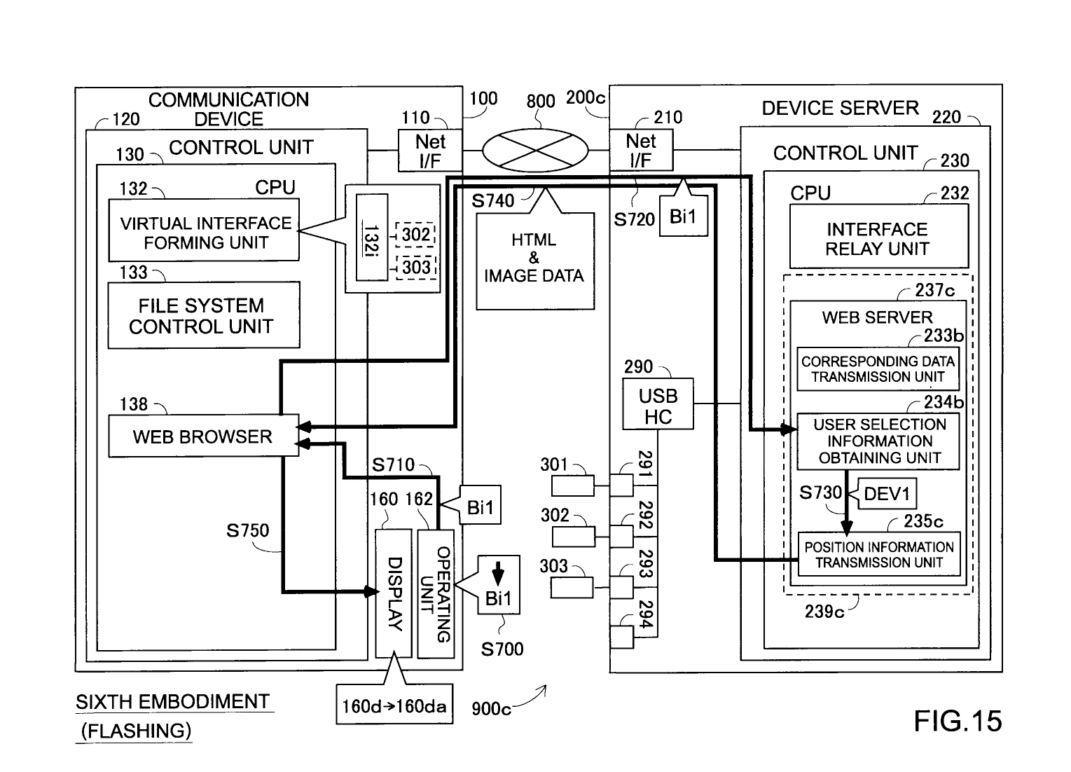

FIG. 15 is a block diagram illustrating one example of the behavior of a communication system 900c in a sixth embodiment of the present invention. The difference between the hardware configuration of the system 900c in the sixth embodiment of the present invention and that of the system 900b in the fifth embodiment shown in FIG. 12 is that the port distinguishing display unit 280 is omitted in the device server 200c of the system 900c. Further, in the system 900c according to the present embodiment, differing from the system 900b in the fifth embodiment, a web server 237c includes a position information transmission unit 235c in addition to the corresponding data transmission unit 233b and the user selection information obtaining unit 234b. In addition, the web server 237c acts as a correspondence relation output unit 239c. Besides, in the block diagram in FIG. 15, as with the block diagram in FIG. 13, the memories 140, 240 and the nonvolatile memories 150, 250 is not shown.

The system 900c in the sixth embodiment executes various processes (except the process in FIG. 14) as does the system 900b in the fifth embodiment. Further, the system 900c in the sixth embodiment executes the process in FIG. 15, instead of the process in FIG. 14 in the fifth embodiment. In FIG. 15, the process indicated by the arrowed lines shows one example of a process when the port display button Bi1 in FIG. 4 is operated.

Steps S700, S710 and S720 are the same as the steps S600, S610 and S620 in the fifth embodiment shown in FIG. 14, respectively. Through these steps S700, S710 and S720, the user selection information obtaining unit 234b identifies which button a user has operated (here, the port display button Bi1).

In the next step S730, the user selection information obtaining unit 234b supplies, to the position information transmission unit 235c, the first device identifying information DEV1 related to the port display button Bi1 operated. In the next step S740, the position information transmission unit 235c transmits, to the web browser 138, web page data displaying an image showing a physical positional relationship of the USB ports of the device server 200. These web page data include, e.g., image data showing a position image. In the next step S750, the web browser 138 allows the display unit 160 to display an image displayed by the web page data received. According to the present embodiment, the web browser 138 allows the display unit 160 to display the management screen 160da according to the second embodiment shown in FIG. 9. As described in FIG. 9, the server information region 160d2a is displaying the position image L1. Then, in the position image L1, a lamp image (here, the first lamp image M1) associated with the device identifying information (the device identifying information reflecting the selection result of a user) supplied in the step S730 flashes. In the next step S740, the position information transmission unit 235c transmits, to the web browser 138, the web page data (e.g., including animation image data) for flashing the lamp image (here, the first lamp image M1) associated with the device identifying information received through the step S730.

As described above, according to the present embodiment, the communication device 100 displays the management screen 160da shown in FIG. 9 on the display unit 160 and therefore the user can easily check on (with) which USB port the USB device selected is mounted (connected).

In addition, according to the present embodiment, both the display of the management screen 160d3 and the display of the position image L1 correspond to the notification of a correspondence relation (the correspondence relation between a USB device and a port connected with the USB device) (FIG. 9). In this manner, according to the present embodiment, the correspondence relation output unit 239c (in FIG. 15) of the device server 200 executes the notification of a correspondence relation in two types.

### Seventh Embodiment

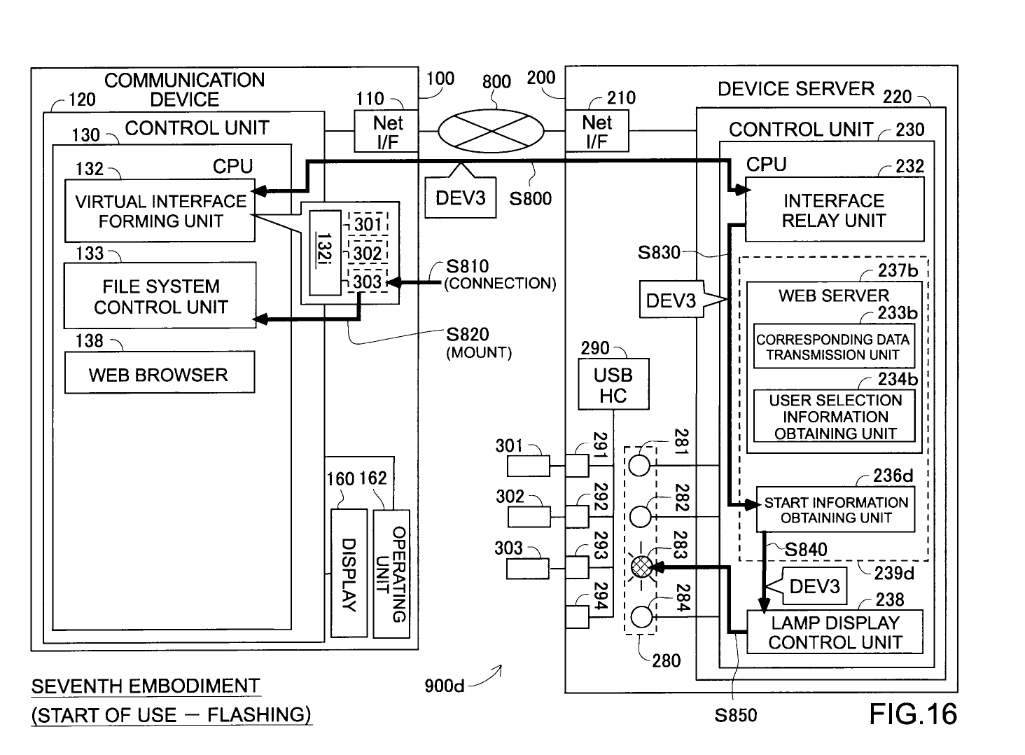

FIG. 16 is a block diagram illustrating one example of the behavior of a communication system 900d in a seventh embodiment of the present invention. The hardware configuration of the system 900d is the same as that of the system 900b in the fifth embodiment shown in FIG. 12. The system 900d executes various processes as does the system 900b (in FIG. 12). Further, according to the present embodiment, the function of a start information obtaining unit 236d is added to that realized by the CPU 230. As with the third embodiment shown in FIG. 10, the start information obtaining unit 236d executes a process flashing a lamp associated with a USB port on (with) which the USB device selected is mounted (connected) to be used by the communication device 100. In FIG. 16, the process flow indicated by the arrowed lines shows one example of a process when the communication device 100 starts to use the third USB memory 303 mounted on the third USB port 293. In addition, the combination of the web server 237b and the start information obtaining unit 236d acts as a correspondence relation output unit 239d.

Steps S800, S810 and S820 are the same as the steps S220, S230 and S240 in the third embodiment shown in FIG. 10, respectively. Through these steps, the communication device 100 starts to use the third USB memory 303 mounted on the third USB port 293. These processes may be executed depending on the user's operation of the start button Bc3 of the management screen 160d in the first embodiment shown in FIG. 4. In this fashion, the interface relay unit 232 allows the communication device 100 to use a USB device requested by the communication device 100

In the next step S830, the start information obtaining unit 236d obtains device identifying information (here, the third device identifying information DEV3) for identifying a USB device requested to be brought into use by the communication device 100.

In the next step S840, the start information obtaining unit 236d supplies the device identifying information obtained to the lamp display control unit 238. In the next step S850, the lamp display control unit 238 flashes the third lamp 283 associated with the third USB port 293 related to the third device identifying information DEV3 received. The process in this step S850 is the same as that in the step S270 in the third embodiment shown in FIG. 10.

As described above, in the process according to the present embodiment, the start information obtaining unit 236d flashes the lamp associated with the USB port mounted on (connected with) the USB device at the request of bringing the USB device into use by the communication device 100. As a result, a user can easily recognize on (with) which USB port the USB device brought into use is mounted (connected). In addition, the start information obtaining unit 236d according to the present embodiment, may be applied to the fifth embodiment shown in FIG. 12 to FIG. 14 and the sixth embodiment shown in FIG. 15.

In addition, the start information obtaining unit 236d may execute the steps S830, S840 in response to the start of using the USB device by the communication device 100. Further, regardless of whether the USB device is brought into use or not, the start information obtaining unit 236d may execute the steps S830, S840 in response to the start of using the USB device by the demand of the communication device 100.

In addition, according to the present embodiment, the display by the port distinguishing display unit 280 corresponds to the notification of a correspondence relation (the correspondence relation between a USB device and the port connected with the USB port).

### Eighth Embodiment

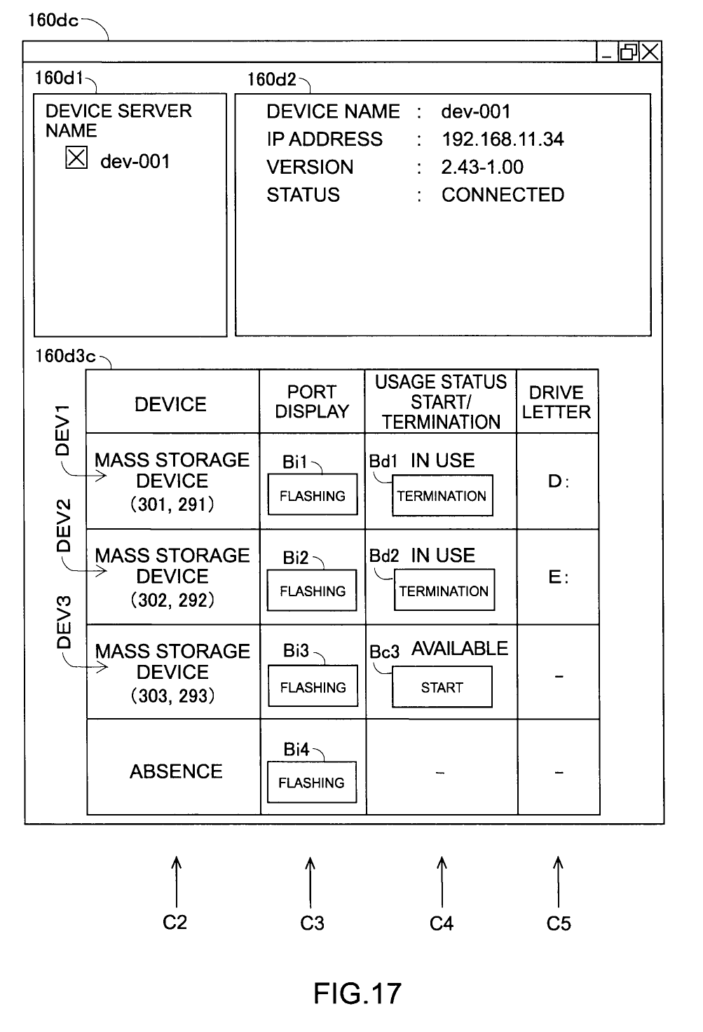

FIG. 17 is an explanatory drawing illustrating one example of a management screen displayed on the display unit 160 (in FIG. 2) of the communication device 100. The difference between the management screen 160dc according to the present embodiment, shown FIG. 17 and the management screen 160d in the first embodiment shown in FIG. 4 is that the port numbers (the first column C1) are omitted in the device region 160d3c. The configuration of the management screen 160dc other than the port number according to the present embodiment, is the same as that of the management screen 160d in the first embodiment. The device region 160d3c of the management screen 160dc may be used instead of the device region 160d3 of the management screen 160d in the first embodiment. The device region 160d3c, e.g., may be applied to the first, second and fifth embodiments shown in FIG. 7, FIG. 9 and FIG. 14, respectively.

In this fashion, the correspondence relation displayed by the management screen 160dc may be one not including the port numbers. In this case as well, one correspondence relation displays one device. Then, a user can select one correspondence relation (one device) with reference to the items (e.g., a drive letter, a usage status or the like) displayed by the management screen 160dc. Specifically, the user can operate the port display button associated with desired information such as a drive letter, a usage status or the like (e.g., the user may operate the first port display button Bi1 associated with the drive letter “D”). In response to this operation, as with the first and second embodiments, the lamp display control unit 238 may flash the lamp associated with the information (the information associated with the USB device, e.g., a drive letter, a usage status or the like) selected by the user. Further, as with the second and sixth embodiments shown in FIGS. 8, 9 and 15, respectively, the position image control unit 137 and the position information transmission unit 235c may display the position image L1 displaying the USB port associated with the information selected by the user in the display 160 in a manner distinguishable from the other USB ports.

In addition, the present invention is not limited to the foregoing embodiments and various modifications are possible within the scope without departing from the gist of the invention. The following modifications, e.g., are possible.

The management screen 160db in the fourth embodiment shown in FIG. 11 may be applied to the fifth to seventh embodiments shown in FIG. 12 to FIG. 16. In this case, a timer (not shown) may be provided in the control unit 220 of the device servers 200, 200c. The corresponding data transmission unit 233b may measure each elapsed time using the timer.

In each embodiment described above, a system configuration is not limited to the foregoing ones and other various configurations may be employed. A device interface (an interface to an electronic device (a peripheral device)), e.g., is not limited to a USB interface and may be other arbitrary interfaces having a function to provide for use of a plurality of ports. The device interface, e.g., may be one pursuant to IEEE 1394. In every case, the relation display control unit 134 (in, e.g., FIG. 3) and the corresponding data transmission unit 233b (in, e.g., FIG. 13) may identify the presence of the electronic device (the peripheral device) and the type of the electronic device, based on various pieces of information obtainable from the electronic device by the device interface (e.g., the USB host controller 290). Further, a method for virtualizing a device interface is not limited to one for encapsulating data communication pursuant to the device interface, using communication packets of a network and may be other arbitrary ones.

The communication device 100 is not limited to a personal computer but may be any arbitrary devices capable of using a device server 200 via a network. The communication device 100, e.g., may be a personal digital assistant, a mobile phone or a tablet computer.

The notification unit (a notification unit for notifying information to a user) is not limited to the display unit 160 (in FIG. 2) for displaying an image and the port distinguishing display unit 280 for displaying one port in a manner distinguishable from the other ports and may be devices of other types for notifying information to a user. The notification unit, e.g., may be a sound device for notifying information to a user by means of sounds and voices.

The manner of display distinguishing one port from the other ports by means of the port distinguishing display unit 280 (in FIG. 1 and FIG. 2) (hereinafter, also referred to as a distinguishing display) does not have to be implemented depending on the flashing of one lamp but may be done so through other various manners of display. The distinguishing display, e.g, may be one in which only one lamp is lighted with all the other lamps kept unlit. Alternatively, the distinguishing display may be one in which one lamp with a given color is lighted. Also, the port distinguishing display unit 280 is not limited to a display device with one port associated with one lamp but may be any other arbitrary one capable of displaying one port in a manner distinguishable from the other ports. For example, the port distinguishing display unit may be one (e.g., a liquid crystal display) for displaying such an image as the position image L1 according to the second embodiment shown in FIG. 9 or a number display for displaying a port number for one port.

A physical layout (a positional relation) of a plurality of ports in the device server 200 (in FIG. 1) is not limited to an in-line one but may be other arbitrary ones. The alignments of a plurality of ports may be provided in a matrix. In any case, the position image control unit 137 (in FIG. 8) according to the second embodiment or the position information transmission unit 235c (in FIG. 15) in the sixth embodiment may allow the display unit 160 to display a position image for displaying the physical positional relationship (alignments) of a plurality of ports. Here, the position image desirably displays one port in a manner distinguishable from the other ports. Such a distinguishing display by the position image may be various ones as is the case with the distinguishing display provided by the foregoing port distinguishing display unit 280. In addition, the position image control unit 137 and the position information transmission unit 235c may dynamically produce data for allowing the display unit 160 to display such a position image, or alternatively, there may be used data prepared in advance. In addition, the data for allowing the display unit 160 to display the position image is not limited to data including image data for displaying the position image but may be other various data. For example, a program such as scripts such as JavaScript (“Java” is a registered trademark) may be employed for allowing the display unit 160 to display the position image.

A hub (a device for branching one USB port into a plurality of USB ports) may be connected with the device servers 200, 200a, and 200c. In this case, a combination of the device servers 200, 200a, 200c and the hub corresponds to the “server system”. Besides, the hub may include the port distinguishing display unit 280 in the first embodiment. In this case, the lamp display control unit 238 may supply, to the hub, the instruction to control the port distinguishing display unit 280.

In any case, when a peripheral device (an electronic device) is connected with a hub port, the correspondence relation notified to a user desirably includes the information indicating the hub and the information indicating the port (e.g., the identifier of a port) connected with the peripheral device. The information indicating the hub may be any arbitrary information enabling a user to recognize that the peripheral device is connected with the hub, and may be, e.g., the identifier of the port (the port of the device server) connected with the hub.

In any case, the port distinguishing display unit 280 may act as an access lamp.

In each of the foregoing embodiments, the correspondence relation notified to a user is not limited to that in each of the embodiments shown in FIGS. 4, 7, 9, 10 to 17, but may be a correspondence relation between any arbitrary items including those indicating a port (e.g., a port identifier or a physical position of the port) and an electronic device (e.g., the type of the electronic device). For example, in the first, second and fourth embodiments shown in FIG. 4, FIG. 9 and FIG. 11, at least some of the items other than “USB port number” and “device” may be omitted.

Further, the correspondence relation may include other various kinds of items than those in the first, second fourth, and eighth embodiments shown in FIGS. 4, 9, 11 and 17. For example, the correspondence relation may include information indicating the time at which an electronic device is connected with a port (hereinafter, referred to as “connection timing information”). The connection timing information is not limited to “the time elapsed since mounting (connection) (the sixth column C6 in FIG. 11)” but may be other various pieces of information. For example, the connection timing information may indicate the order of connecting the electronic device with the device server.

Also, the correspondence relation may include the information indicating the time at which an electronic device started to be used (hereinafter, referred to as usage timing information). The usage timing information is not limited to the elapsed time (the seventh column C7 in FIG. 11) since the start of use but may be other various pieces of information. For example, the usage timing information may indicate the order of starting the use by the communication device 100. In addition, instead of the corresponding data transmission units 233, 233b (e.g., in FIGS. 2 and 12) of the device server 200, the relation display control unit 134 of the communication device 100 may produce usage timing information.

In addition, a plurality of the communication devices may use the device servers 200, 200a, 200c, respectively. In this case, a correspondence relation notified to a user (e.g., the correspondence relation displayed on the display unit 160) may be different for every communication device. For example, some communication device may notify only the drive letter used for that communication device and may not notify drive letters used for the other communication devices. Alternatively, one communication device may use a plurality of the device servers. In that case, the server name region 160d1 of the management screens 160d, 160da, 160db and 160dc (in FIGS. 4, 9, 11 and 17) in the first, second, fourth and eighth embodiments may display a list of a plurality of usable device servers. Then, the relation display control unit 134 (in, e.g., FIG. 3) and the corresponding data transmission unit 233b (in, e.g., FIG. 13) may allow the display unit 160 to display the correspondence relation relative to one device server selected by a user from the list.

Also, the correspondence relation may be one between an item identifying an electronic device (e.g., the type of the electronic device) and one or more other arbitrary items, without including any items indicating a port (e.g., an identifier of the port). For example, the correspondence relation may include an electronic device (e.g., the type of the electronic device) and a selection operating unit for selecting the electronic device to be selected as a target of the distinguishing display (in, e.g., FIGS. 7 and 8), such as the port display button in the third column C3 in FIG. 4. In this case, by operating the selection operating unit, a user can easily identify the port connected with the electronic device selected. Then, by the port displayed, the user can easily distinguish the specific electronic device from the other electronic devices.

It should be noted that the data transmitted for notifying the correspondence relation to the notification unit (e.g., the display unit 160 in FIG. 2) to a communication device such as the communication device 100 by a device server such as the device server 200 in FIG. 13 (hereinafter, such data will be referred to as “correspondence display data) are not limited to HTML data but may be various web page data. The correspondence display data, e.g., may be a program (e.g., scripts such as JaveScript (Java is a registered trademark) or the like) for allowing the display unit 160 to display a correspondence relation. Further, the correspondence display data are not limited to the web page data but may be various data for controlling a notification unit.

In each embodiment described above, the communication device 100 and the device servers 200, 200a, 200c use device identifying information (e.g., the third device identifying information DEV3 in FIG. 5) in order to identify one electronic device (one peripheral device) connected with a device server. This device identifying information is not limited to a port number but may be other arbitrary information different for every electronic device. The device identifying information, e.g., may be an address assigned to a USB device. Thus, when a hub is connected with the USB port of the device server 200, the communication device 100 and the device servers 200, 200a, 200c can adequately identify the USB device connected with the USB port of the hub.

In the foregoing embodiments, as the mode of the notification of the correspondence relation (correspondence relation between a peripheral device (an electronic device) and the port connected with the peripheral device), three modes have been described. The first mode is one to display the information indicating the port (e.g., the identifier of the port) and the information indicating the peripheral device (e.g., the type of the peripheral device) in association with each other (e.g., the device regions 160d3, 160d3b, 160d3c (in FIG. 4, FIG. 11, FIG. 17)). The second mode is one to display the port associated with the device identifying information in a manner distinguishable from the other ports (e.g., the flashing of the lamp in FIG. 7, FIG. 10, FIG. 14, and FIG. 16)). The third mode is one to display an image showing the port associated with the device identifying information in a manner distinguishable from the other ports (e.g., the display of the position image L1 in FIG. 9).

The mode of the notification of the correspondence relation is not limited to the foregoing modes but may be other arbitrary ones. Further, the system may notify one mode of the correspondence relation and may notify two modes of the correspondence relations and further may notify three or more modes of the correspondence relations. The system, e.g., may notify only one mode of the correspondence relation from among the foregoing first, second and third modes of the correspondence relations. In any case, the notification unit of the communication device may notify the correspondence relation, while the notification unit of the device server may notify the correspondence relation. For example, the device server 200 in FIG. 12 may include an image display unit and the corresponding data transmission unit 233b may allow the image display unit to display the management screens such as those in the first, second, fourth and eighth embodiments (e.g., management screens in FIGS. 4, 9, 11 and 17) (the corresponding data transmission unit 233b may transmit (output) data for showing the management screen to the image display unit). Besides, instead of the corresponding data transmission unit 233b of the device server, a communication device (e.g., the relation display control unit 134 in FIG. 2 may allow the image display unit of the device server to display the management screens (e.g., the management screens in FIGS. 4, 9, 11 and 17) such as those in the first, second, fourth and eighth embodiments (the communication device may transmits data for showing a management screen to a device server).

Further, the condition of notifying a correspondence relation may be an arbitrary one. As in the first, second, fifth and sixth embodiments shown in FIG. 7, FIG. 8, FIG. 14 and FIG. 15, respectively, the system may notify a correspondence relation at the request of a user. Furthermore, as in the third, seventh embodiments shown in FIG. 10, FIG. 16, respectively, the system may automatically notify a correspondence relation depending on the fact that a given condition is satisfied. Moreover, the system may adopt an condition arbitrarily selected from the conditions described in the foregoing embodiments.

In each embodiment described above, the user selection unit 136 (in, e.g., FIG. 2) and the user selection information obtaining unit 234b (in, e.g., FIG. 14) may permits a user to select not only from one or more correspondence relations (in FIGS. 4, 9, 11 and 17) displayed on the display unit 160 but from arbitrary information associated with a peripheral device (an electronic device). Generally, the information (item) selected by the user in order to display one port in a manner distinguishable from the other ports may be arbitrary information associated with the peripheral device (the electronic device). The information (item) that can be selected, e.g., may be the item arbitrarily selected from “the port number (the first column C1 in FIG. 4)”, “the type of a device (the second column C2)”, “the usage status (the fourth column C4)” “the drive letter (the fifth column C5”), “the time elapsed since mounting (connection) (the sixth column C6” in FIG. 11), and “the time elapsed since the start of use (the seventh column C7)”. The user selection unit 136 and the user selection information obtaining unit 234b, e.g., may output device identifying information depending on the selection of the drive letter by the user.

The architecture of each of the foregoing embodiments or part thereof may be combined with those of other embodiments. The start information obtaining unit 236d in the sixth embodiment shown in FIG. 16, e.g., may be applied to the system 900 in the first embodiment shown in FIG. 2. In this case, the start information obtaining unit 236d executes the steps S830, S840 as is done by the process flow in the sixth embodiment shown in FIG. 16. Accordingly, if the communication system 100 does not transmit a command to the device server 200, the port distinguishing display unit 280 of the device server 200 can automatically display the USB port mounted with the USB device requested to be brought into use.

In each embodiment described above, part of the architecture realized by hardware may be replaced by software and conversely, whole of or part of the architecture realized by software may be replaced by hardware. For example, the function of the corresponding data transmission unit 233 in the first embodiment shown in FIG. 2 may be realized by a dedicated hardware circuit with a logic circuit.

Further, when all or some of the functions according to the present invention are realized by software, such software can be provided in the form of software stored in a nonvolatile computer-readable recording medium. In the present invention, “a nonvolatile computer-readable recording medium” includes not only a portable recording medium such as a flexible disc and a CD-ROM but an internal storage device within a computer such as various types of RAMs, ROMs and an external storage device not fixed within a computer such as a hard disc or the like.

What is claimed is:

1. A communication system including a communication device and a server system connected with each other in a manner capable of communicating via a network, the server system allowing the communication device to use at least one electronic device via the network and at least one of the communication device and the server system being provided with a notification unit for notifying information to a user,
wherein the server system comprises:
a network interface to the network;
a device interface having a function to provide for use of a plurality of ports for connecting with the electronic device;
a device interface relay unit for relaying data communication between the communication device and the device interface via the network interface in order to allow the communication device to form a virtual device interface corresponding to the device interface of the server system; and
a correspondence relation output unit for outputting data on a correspondence relation between a plurality of items, including items identifying the electronic device connected with the port of the device interface and the port connected with the electronic device, and
wherein the communication device comprises:
a network interface to the network;
a virtual interface control unit for forming a virtual device interface corresponding to the device interface of the server system, by communicating with the server system via the network; and
a notification control unit for allowing the notification unit to notify a correspondence relation between a plurality of items, including items identifying the electronic device connected with the port of the device interface and the port connected with the electronic device, based on the data from the correspondence relation output unit.

2. A communication device comprising:
a network interface to a network;
a virtual interface control unit for forming a virtual device interface corresponding to a device interface of a server system, by communicating, via the network, with the server system including the device interface having a function to provide for use of a plurality of ports for connecting with at least one electronic device; and
a notification control unit for allowing a notification unit for notifying information to a user to notify a correspondence relation between a plurality of items, including items identifying the electronic device connected with the port of the device interface and the port connected with the electronic device.

3. The communication device according to claim 2, wherein the server system comprises a port distinguishing display unit acing as a display unit operable as the notification unit to display one port selected from among a plurality of the ports in a manner distinguishable from the other ports, and
wherein the notification control unit comprises a display command transmission unit which obtains device identifying information for identifying one electronic device from among one or more electronic devices connected with the server system and transmits, to the server system, a command to allow the port distinguishing display unit to display the port connected with the electronic device identified by the device identifying information in a manner distinguishable from the other ports.

4. The communication device according to claim 2, further comprising an image display unit acting as a display unit operable as the notification unit,
wherein the notification control unit further comprises a position image control unit for allowing the image display unit to display a position image showing a physical positional relationship between a plurality of the ports, and
wherein the position image control unit obtains device identifying information for identifying one electronic device from among one or more electronic devices connected with the server system to thereby allow the image display unit to display the position image showing the port connected with the electronic device identified by the device identifying information in a manner distinguishable from the other ports.

5. The communication device according to claim 3, wherein the notification control unit further comprises a user selection unit for allowing a user to select information associated with one electronic device from among one or more electronic devices connected with the server system, and
wherein the device identifying information includes information for identifying the electronic device associated with the information selected by the user.

6. The communication device according to claim 3, wherein the device identifying information includes information for identifying an electronic device selected to be used by the communication device from among one or more electronic devices connected with the server system.

7. The communication device according to claim 2, wherein the notification control unit allows the notification unit to notify the correspondence relation including, as one of a plurality of items in the correspondence relation, information indicating a time at which the electronic device was connected with the port.

8. The communication device according to claim 2, wherein the notification control unit allows the notification unit to notify the correspondence relation including, as one of a plurality of items in the correspondence relation, information indicating a time at which the electronic device started to be used.

9. The communication device according to claim 2, wherein when the electronic device is a storage device for providing a storage region for storing data, the notification control unit allows the notification unit to notify the correspondence relation including, as one of a plurality of items in the correspondence relation, an identifier of the storage region used to identify the storage region in the communication device.

10. A communication device comprising:
a network interface to a network;
a virtual interface control unit for forming a virtual device interface corresponding to a device interface of a server system, by communicating, via the network, with the server system including the device interface having a function to provide for use of a plurality of ports for connecting with one or more electronic devices; and
a notification control unit for outputting data for notifying to a user information on a correspondence relation between a plurality of items, including items identifying the electronic device connected with the port of the device interface and the port connected with the electronic device.

11. A non-volatile recording medium with such a program stored therein that enables a computer, which includes a network interface to a network and a notification unit for notifying information to a user, to have a function to allow the notification unit to notify a correspondence relation between a plurality of items, including items identifying at least one electronic device connected with a port of a device interface and the port connected with the electronic device, by allowing the computer to communicate with, via the network, a server system including the device interface providing for use of a plurality of ports for connecting with the at least one electronic device.

12. A server system for allowing a communication device to use one or more electronic devices via a network, the server system comprising:
a network interface to a network;
a device interface having a function to provide for use of a plurality of ports for connecting with the electronic device;
a device interface relay unit for relaying data communication between the communication device and the device interface via the network interface in order to allow the communication device to form a virtual device interface corresponding to the device interface of the server system; and
a correspondence relation output unit for allowing a notification unit for notifying information to a user to notify a correspondence relation between a plurality of items, including items identifying the electronic device connected with the port of the device interface and the port connected with the electronic device.

13. A server system for allowing a communication device to use one or more electronic devices via a network, the server system comprising::
a network interface to a network;
a device interface having a function to provide for use of a plurality of ports for connecting with the electronic device; and
a device interface relay unit for relaying data communication between the communication device and the device interface via the network interface in order to allow the communication device to form a virtual device interface corresponding to the device interface of the server system; and
a correspondence relation output unit for outputting data for notifying to a user information on a correspondence relation between a plurality of items, including items identifying the electronic device connected with the port of the device interface and the port connected with the electronic device.

14. A non-volatile recording medium with such a program stored therein that enables a computer which includes a network interface to a network, a device interface providing for use of a plurality of ports for connecting with one or more electronic devices, and a server system side notification unit for notifying information to a user, to have a function to output data for allowing the server system side notification unit to notify a correspondence relation between a plurality of items, including items identifying the electronic device connected with the port of the device interface and the port connected with the electronic device.
